(19) United States
(12) Patent Application Publication
(10) Pub. No.: US 2022/0228400 A1
(43) Pub. Date: Jul. 21, 2022

(54) ALARM DEVICE

(71) Applicant: Anton Valeriiyovych Remiz, Kyiv (UA)

(72) Inventor: Anton Valeriiyovych Remiz, Kyiv (UA)

(21) Appl. No.: 17/594,870

(22) PCT Filed: Apr. 29, 2020
(86) PCT No.: PCT/UA2020/000048

§ 371 Date: Nov. 1, 2021

(30) Foreign Application Priority Data
May 2, 2019 (UA) A2019 04650
May 2, 2019 (UA) A2019 04651
May 2, 2019 (UA) A2019 04653
May 2, 2019 (UA) U2019 04654
May 2, 2019 (UA) U2019 04655
May 2, 2019 (UA) U2019 04657
Aug. 14, 2019 (UA) U2019 09292
Aug. 15, 2019 (UA) U2019 09337
Aug. 15, 2019 (UA) U2019 09341
Aug. 15, 2019 (UA) U2019 09343
Aug. 15, 2019 (UA) U2019 09344
Aug. 15, 2019 (UA) U2019 09345
Aug. 15, 2019 (UA) U2019 09349
Nov. 1, 2019 (UA) U2019 10817
Nov. 1, 2019 (UA) U2019 10829
Nov. 22, 2019 (UA) U2019 11390
Apr. 27, 2020 (UA) A2020 02590

(51) Int. Cl. E05B 45/06; E05B 17/18; G08B 3/10; G08B 13/02

(52) U.S. Cl. CPC E05B 45/06; E05B 17/183; G08B 3/10; E05B 2045/0655; E05B 2045/0645; E05B 2045/067; E05B 2045/0665; G08B 13/02

(57) ABSTRACT

Proposed invention is an alarm device for protecting various type of locks of premises, buildings, apartments, rooms, vehicles, safes, money terminals and for other objects by means of timely, more early informing, interaction with alarm system or digital-electronic device of persons observing protected object in result of attempts of burglary, unauthorized opening, damaging or even preliminary studying the lock by attacker.

### APPLICATION FIELD

The invention relates to signaling means for the protection of various objects, including for the protection of premises, buildings, apartments, rooms, vehicles, safes, money terminals and for other objects of protection. The construction of the invention can be applied to different locks and with different locks (as an accessory). In particular, the invention twenty is an alarm device.

### PRIOR ART

Burglar alarms and various alarm devices are the most effective means of protecting objects, however, most known alarm systems are triggered only after the intruder has overcome all mechanical means of protection and closure of the protected object and got inside the protected object—in an apartment, house, vehicle, store, in a safe. Sometimes well-known alarm systems do not work instantly, but after 30-40 seconds, which are usually “allotted/provided” alarm system to authorized disable the alarm system. For such situations, this time is quite long, since the rapid response guard team does not know about the “burglary, intrusion” event and the alarm is triggered not immediately, that is, not instantly, but only after 30-40 seconds. On average (according to well-known statistics) usually the rapid response security group after receiving an alarm signal needs from 4 up to 10 minutes to get to the protected object, and in most cases this time is quite enough for an attacker to search the protected object, steal valuables and be able to leave the territory of the protected object. Known “Security device against breaking the door lock in the room”, containing a base, a cover, a movable connection between the cover and the base and elements for detecting changes in the position of the cover, where the base is configured to be installed on the surface of the protected object in the area of the lock of the protected object, and the cover is attached to base using a movable connection between the cover and the base with the ability to move the cover relative to the base to close and open access to that area of the lock of the protected object, access to which is necessary to open this lock. But this is a safety device is quite simple and does not allow increasing the sensitivity of the alarm device to attempts to break or damage it, or to attempts to preliminary study the type of lock of the protected object. Also, the design of this invention does not improve the reliability and speed of notification of an attempt at unauthorized hacking, damage alarm device and an attempt to preliminary study the type of lock or unauthorized breaking and/or opening of the lock of the protected object. In addition, such a design does not allow convenient installation and use of this “Safety device against breaking the door lock in the room” for various objects of protection, such as—safes, vehicles, biometric locks and others.

Most close to the proposed invention is the construction “Warning systems”, which contains a base, a cover, a movable connection between the cover and the base, and elements for detecting changes in the position of the cover. In this case, the base is made with the possibility of its installation on the surface of the protected object in the area of the lock of the protected object, and the cover attached to the base by means of a movable connection between the cover and the base with the ability to move the cover relative to the base to close and open access to the area of the lock of the protected object, which is necessary to open this lock, and elements for detecting the change of cover position are made with the possibility of interaction with the alarm system when the cover moves relative to the base (US patent for invention No. 5835014, IPC E05B 45/06, publ. 10.11.1998 [2]). This constructive solution provides for the use of autonomous signaling, which is an integral part of the warning system. And said standalone alarm triggered directly in the device when the cover is moved relative to the base. Based on the description of this invention, it was designed, created and intended to be used primarily for the protection of ATMs and/or for self-service terminals (for objects that are located autonomously and can always or temporarily be not connected to a common alarm system), and, accordingly, this invention solves the problem of protecting the lock which is an alternative mechanical access to a protected autonomous object in the absence/disconnection of power of the general alarm system of ATMs or self-service terminals. But such a “warning system” does not allow to increase the sensitivity of the alarm device to attempts to break it or damage, or attempts to preliminary study the type of lock of the protected object. Also, this design does not allow to increase the reliability and speed of notification of an attempt of unauthorized burglary, damage to the alarm device and an attempt to preliminary study the type of lock of the protected object or unauthorized burglary and/or opening the lock of the protected object. Also, the features of this design do not allow convenient installation and use of this “Warning System” at various objects of protection, such as doors of premises, vehicles, biometric locks and others. In addition, the disadvantages of these known technical solutions (“Security device against breaking the door lock in the room” and “Warning system”) is that an intruder can bypass their protective function by drilling, sawing off or bending the part of the cover that covers the area of the lock or area closes the lock hole on the base, access to which is necessary to open this lock. In serial production, the designs of these products can be carefully studied by attackers, and methods of overcoming such protection will become publicly available to them (attackers).

### Technical Task (Technical Result)

The technical task of the present invention is the creation of such alarm device, the design of which would improve the sensitivity of the alarm device to attempts to break or damage it, or to attempts to preliminary study the type of lock of the protected object, and also increase the reliability and speed of notification of an attempt at burglary, damage to the alarm device and an attempt to preliminary study the type of lock of the protected object, burglary or unauthorized and/or opening of the security object lock.

An additional technical task of the invention is the creation of the most versatile alarm device, the design of which would allow it to be conveniently installed and used at various security objects.

### Disclosure of Invention

The problem is solved in that the alarm device 1 contains a base 2, a cover 3, a movable connection 4 between the cover 3 and the base 2, and elements for detecting the change in the position of the cover. Where in the base 2 is made with the possibility of its installation on the surface of the protected object in the area 7 of the lock of the protected object, and the cover 3 is attached to the base 2 by means of a movable connection 4 between the cover 3 and the base 2 with the possibility of moving the cover 3 relative to the base 2 to close and open access to that area 7 of the lock of the protected object, which is necessary for opening of this lock, and the elements for detecting changes in the position of the cover 3 are made with the possibility of interacting with the alarm system when the cover 3 moves relative to the base 2.

What is new is that the alarm device 1 contains a system for detecting a change in the state of the cover 5, which is formed from at least cover 3, a movable connection 4 between the cover 3 and the base 2 and at least one electronic component 6, which, when the state of the cover 3 changes, interacts with the alarm system. and at least part of the one of the elements of the system for detecting the change in the state of the cover 5 in position alarm device 1 in state when the cover 3 covers the area 7 of the lock of protected object, access to which is necessary to open this lock, is located in front of this area 7 of the security object lock, access to which is necessary to open this lock.

For some specific conditions and use cases, the proposed alarm device is characterized by the following features, that are improve and clarify a combination of features of independent points claims.

The base 2 contains a hole 8 for access to the lock of the protected object, which is made in that part of the base 2, which, when the alarm device 1 is installed on the protected object, is located in that area 7 lock of the protected object, access to which is necessary to open this lock, while part of at least one of the elements of the system for detecting the change in the state of the cover 5 in the position of the alarm device 1, when the cover 3 closes the hole 8 of the base 2, is located in front of this hole 8 for access to lock of the protected object.

The system for detecting the change in the state of the cover 5 is formed at least from the cover 3, the movable connection 4 between the cover 3 and the base 2, and at least one electronic component 6 as a tilt sensor 12 or a mechanical tilt sensor, which is configured to be connected to an alarm system protected object and is located inside the cover 3, and which is made with ability, when the cover 3 is moved relative to the base 2, to interacts with the alarm system.

The system for detecting the change in the state of the cover 5 is formed at least of the cover 3, the movable connection 4 between the cover 3 and the base 2, and at least one electronic component 6 as a gyroscope 13 or as accelerometer 14, or as a gyroscope-accelerometer 15, which is configured to be connected to the alarm system of the protected object and is located inside the cover 3 or in the movable connection 4 between the cover 3 and the base 2, and which is made with ability, when the cover 3 moves relative to the base 2, to interact with system alarm.

The system for detecting the change in the state of the cover 5 is formed at least from the cover 3, inside which there is at least one permanent magnet 17, the movable connection 4 between the cover 3 and the base 2, and at least one electronic component 6 in as a magnetically sensitive sensor 16, which is made with the ability to connect to the alarm system of the object protection, and which is located in the base 2, while the magnetically sensitive sensor 16, when the cover 3 moves relative to the base 2 or when the state of the cover 3 changes, interacts with the alarm system.

The system for detecting the change in the state of the cover 5 is formed at least from the cover 3, which contains the inner plane 28, the movable connection 4 between the cover 3 and the base 2, and at least of one electronic component 6 as an electronic photosensitive element 18 which is made with ability to connect to the alarm system of the protected object, and which is mounted in the base 2 in such a way that its photosensitive surface 29 is located to the inner plane 28 of the cover 3, while the cover 3 has such an internal plane 28 that is covered with a material or contains material or is made of a material in which cracks or irregularities or a change in the surface pattern are formed as a result of mechanical or thermal influence, or it loses its light conductivity, and such an internal the plane 28 of the cover 3 is located on the inner surface of the cover 3, which covers the outer side of the base 2, the electronic photosensitive element 18, area 7 or hole 8 for access to the lock of the protected object in the position of the alarm device 1 with the closed cover 3, while the electronic photosensitive element 18 made with ability to interact with alarm system while the change in the state of the cover 3.

The system for detecting the change in the state of the cover 5 is formed at least of the cover 3, a movable connection 4 between the cover 3 and the base 2, and at least one electronic component 6 as a flex sensor 19, which is fully or partially located in the movable connection 4, and is made with the ability to connect to the alarm system of the guarded object, and when the movement of the cover 3 relative to the base 2 interacts with the alarm system.

The alarm device 1 additionally contains at least one radio module 20 or radio module 20 with cryptographic protection of the radio channel, which is installed inside the cover 3 or inside the base 2, and the radio module 20 connected to at least one electronic component 6 of the system for detecting the change in the state of the cover 5, which, when the cover 3 is moved relative to the base 2, interacts with the alarm system, while the radio module 20 is made with ability to transmit a radio signal about the change in the state of the cover 3 to the alarm system or electronic digital devices of persons—observers behind the protected object.

To at least one electronic component 6 of the system for detecting the change in the state of the cover 5, which, when the state of the cover 3 changes, interacts with the alarm system, is connected to at least one resistor 21 or to a variable resistance resistor, which is located inside the cover 3 or inside the base 2, or in a movable connection 4 between the cover 3 and the base 2.

At least one electronic component 6, which, when the state of the cover 3 changes, interacts with the alarm system, is connected to the conductive wires 22 or is installed on the circuit board 23, while this, part of these electrically conductive wires 22 or part of the circuit board 23 in the position when the cover 3 covers the base 2 are located inside the cover 3 and/or in a movable connection 4 in front of the area 7 or in front of the hole 8 of the base 2 for accessing the lock of the protected object, in addition electrically conductive wires 22 or terminals of the circuit board 23 are connected to the alarm system directly or using a radio signal.

At least to one of electronic component 6 of the system for detecting the change in the state of the cover 5, magnetically sensitive sensor of type “Reed switch” 30, which is located inside the cover 3 or inside the base 2, or in movable connection 4 between cover 3 and base 2 is connected.

At least one of the two parts of the alarm device 1—the cover 3 and/or the base 2 contains at least one (first) permanent magnet 31, while the other part of the alarm device 1 also contains at least one corresponding second permanent magnet 32 or contains magnetic material 33, or partially made of magnetic material 33, which interacts with the first permanent magnet 31 or the one of the two parts of the alarm device 1.

The movable connection 4 between the cover 3 and the base 2 is made and located in the lower part of the alarm device 1.

The cover 3 and/or the base 2 contains a limiting element 11 for changing the position of the cover 3.

The alarm device 1 additionally contains an electric sound siren 34 installed inside the base 2 or inside the cover 3, and which is connected to the system for detecting the change in the state of the cover 5 and/or to alarm system.

The alarm device 1 contains a radio frequency identification or near-field communication module 35, which is installed inside the base 2 or inside the cover 3.

Alarm device 1 additionally contains a coded or mechanical, or electromagnetic, or electromechanical lock 36, which is made with ability to block the opening of the cover 3 when it is in the closed position.

The base 2 contains holes 9 for attaching the alarm device 1 to the protected object.

The alarm device 1 additionally contains an electrical switch 37 installed in the base 2 in such a way that when the alarm device 1 is removed/unmounted from the surface of the security object, the electrical switch 37 interacts with the alarm system.

The alarm device 1 contains a biometric scanner 38, which is located in the cover 3 or in the base 2.

The cover 3 contains a hole 10 for accessing the lock of the protected object.

The alarm device 1 additionally contains at least one shock sensor and/or vibration sensor 39, which is made with ability to be connected to the alarm system of the protected object and is located inside the cover 3, or inside the base 2, or in a movable connection 4 between the cover 3 and the base 2.

The alarm device 1 additionally contains at least one data input/output port 40, which is located inside the cover 3 or inside the base 2.

The alarm device 1 additionally contains at least one microcontroller 41, which is located inside the cover 3 or inside the base 2.

The alarm device 1 additionally contains at least one photo/video camera 42, which is located inside the cover 3 or inside the base 2.

### Inventive Level

The design of the invention makes it possible to achieve the set technical objectives. The totality of all essential features of the proposed alarm device, including its new essential features, allowing to decide several set technical problems, the simultaneous achievement of which is the achievement of the technical result of the invention.

The alarm device 1 is intended for installation on various objects of protection (on their doors and in other places of opening) (FIGS. 1, 2, 7) with the purpose of preventing unauthorized opening of these objects of protection and interference on their territory.

The alarm device 1 consists of a base 2 and a cover 3, which are interconnected by a movable connection 4. The base 2 is made with the possibility of installing it on the surface of the protected object in the area 7 of the lock of protected object. The cover 3 is attached to the base 2 by means of a movable connection 4 with the ability to move the cover 3 relative to the base 2 to close and open access to that area 7 of the lock of the protected object, access to which is necessary to open this lock.

The alarm device 1 also contains the system for detecting the change in the state of the cover 5, which interacts with the alarm system:
when moving the cover 3 relative to the base 2;
in case of destruction or damage to cover 3 and damage to movable connection 4, or base 2, which directly or indirectly affect the condition of cover 3 (for example, its integrity, or its position in space);
when impacting (creating vibration) on the alarm device 1 and including on the cover 3;
at attempts to disconnect, deactivate the alarm device 1, incl. with external magnetic influence on the alarm device 1 and the cover 3;
when trying to preliminary study the type of lock of the protected object, which directly or indirectly affect the state of the cover 3 (for example, on its integrity, or on its position in space);
when trying to destroy or remove the alarm device 1 and in including cover 3 from the surface of the protected object.

That is, with any change in the state of the cover 3, including when it moves from its stationary (immovable) position, destruction, damage and other similar changes, the system for detecting the change in the state of the cover 5 sends a signal to the alarm system, or interrupts existing connection with the alarm system, which is also a signal anxiety. In the context of this patent specification and patent claims, the term “alarm system” means any alarm system installed at the protected object and which is capable of receiving a signal from any alarm devices, sensors, controllers and others. devices, and which is able to transmit the alarm signal to authorized persons and/or to centralized security and control devices.

Most of the known alarm systems and devices are designed and configured in such a way that the alarm is “activated” after the security object is opened and after the intruder enters the security zone. That is, in the area of alarm protection of objects, there is a problem that during the time when an intruder “opens/destroys/examines” a lock or other device that is designed to gain access to a protected object, the alarm system does not “activate” and does not “generate” an alarm signal. Accordingly, in most cases, the alarm is triggered after breaking the lock and after the intruder gets into the protection zone of the protected object, it provides the intruder with a short but definite time to commit a crime. The main object of the proposed invention is to provide a alarm device that would be “protect” directly the lock and/or area of the lock of the protected object, and which would create and direct signal alarm even “before” or “at the moment” of opening/destruction/study of the lock of the protected object.

To solve this problem, and as already noted, the alarm device 1 contains the system for detecting the change in the state of the cover 5, which interacts with the alarm system for any change in the state of the cover 3. Part of the new features of the invention is that the system detecting the change in the state of the cover 5 is formed at least from the cover 3, movable connection 4 between the cover 3 and the base 2, and at least one electronic component 6, which, when the state of the cover 3 is changed, interacts with the alarm system.

Cover 3 is directly the part of the construction that the first comes under the influence at the moment of intervention in the area 7 of the lock or to the lock of the protected object, therefore it (cover 3) is that necessary part of the system for detecting the change in the state of the cover 5, which changes the stationary physical stationary and integral state of the part of the alarm device 1. When interfering with area 7 of the lock or to the lock of the protected object, the cover 3, as minimum, changes its position in space, which allows effective use this physical phenomenon to start generating and directing a signal (electrical, radio, electronic-digital) to the alarm system.

The movable connection 4 between the cover 3 and the base 2 is a mechanism that is designed and which allows the cover 3 to be “Movable” relative to the base 2 and relative to the area 7 of the lock of the protected object. Accordingly, the movable connection 4 is also a necessary element of the system for detecting the change in the state of the cover 5, without which this system 5 and, in general, the entire alarm device 1 is not able to work effectively and perform the necessary functions.

A significant feature of the new design is the presence, as the at least one electronic component 6 which, when state of the cover 3 changes interacts with the alarm system. Unpredictable and unusual is the fact that:
as at least one electronic component 6 can be various types of sensors and devices have been used that allow you to create and send a signal to the alarm system as a result of a change in the state of the cover 3, for example, as a result of a change in its position, or as a result of its damage or destruction;
the specified at least one electronic component 6 can be installed in different parts of the alarm device 1 (in the cover 3, in the base 2, in the movable connection 4), depending on the type of electronic component 6, and depending on the design features of the alarm device 1 in some cases of its implementation.

The invention provides that the electronic component 6 is connected and interacts with the alarm system. In some cases of implementation and operation of the alarm device 1, the electronic component 6 can be connected to the alarm system using conductive wires 22 and/or the circuit board 23. In addition, the electronic component 6 can interact with the alarm system using the radio module 20 (which in some cases, the bits can be installed in the construction of the alarm device 1 and connected to at least one electronic component 6).

The presence of an electronic component 6, which, when the state of the cover 3 changes, interacts with the alarm system, is a prerequisite for the effective operation of the system for detecting the change in the state of the cover 5 and alarm device 1 as a whole.

Thus, the presence of each of these elements of the system for detecting the change in the state of the cover 5 is an important and absolutely necessary condition for the effective operation of the alarm device 1. Namely, the cover 3 has the ability to move only with the help of a movable connection 4, the cover 3 when changing the state, including when changing the position (at the moment of movement, when trying to destroy/damage and/or study by an intruder the construction of the alarm device 1) is the primary object that physically affects the “initiation” of work (switching on/opening, another signal formation) of the electronic component 6; electronic component 6 interacts with the alarm system. Accordingly, the presence of these components, the totality of the cover 3, the movable connection 4 between the cover 3 and the base 2 and at least one electronic component 6, which, when the state of the cover 3 changes, interacts with the alarm system, and a certain relationship between them allow you to create and effectively use a system for detecting changes in the state of the cover 5 in the construction of the proposed invention.

The possibility of installing the base 2 on the surface of the protected object in the area 7 of the lock of the protected object, the “mobility” of the cover 3 relative to the base 2 and relative to the area 7 of the lock of the protected object, which is carried out with using a movable connection 4 between the base 2 and the cover 3, the presence of at least one electronic component 6 in the detecting system for changing the state of the cover 5, which, when the state of the cover 3 changes, interacts with the alarm system by sending a signal or by interrupting the electrical circuit “alarm device 1—system alarms”, allow to achieve a part of the technical result, namely, to increase the reliability and speed of notification of an unauthorized burglary attempt, damage to the alarm device and an attempt to preliminary study the type of the lock of protected object or unauthorized burglary and/or opening the lock of protected object.

The design of the invention also provides that in the stationary operating position of the alarm device 1, when the cover 3 covers the area 7 of the lock of the protected object, access to which is necessary to open this lock, part of at least one of the elements of the system for detecting the change in the state of the cover 5 (meaning: part of the cover 3 and/or part of the movable connection 4 and/or part of the electronic component 6) is located in front of this area 7 of the security object lock, access to which is necessary to open this lock. The specified location of part of at least one of the elements of the system for detecting the change in the state of the cover 5 in front of the area 7 of the lock of the protected object is a new essential feature of the proposed alarm devices 1.

The constructive arrangement of a part of one of the elements of the system for detecting a change in the state of the cover 5 in front of the area 7 of the lock of the protected object leads to the effect that for the initial access to the lock, an intruder must in any case “touch” and “come into contact” with the cover 3 and/or with movable connection 4 and/or with electronic component 6, or at least with parts thereof. In the vast majority of cases of the invention in the composition of the cover 3 and/or in a movable connection 4 is always set to the electronic component 6, or a portion thereof, or in some cases of the invention in the composition of the cover 3 and/or in a movable connection 4 may be installed additional electronic components, for example, such as: radio module 20 or radio module 20 with cryptographic protection of the radio channel, which can be with an autonomous battery and/or resistor 21, which are always connected to electronic components 6 and is part of an electrical circuit that is formed to interact with system alarm.

In addition, in some cases, the implementation of the alarm device 1, when in the system for detecting the change in the state of the cover 5, and in particular, when the cover 3 or the movable connection 4 contains conductive wires 22 and/or a circuit board 23, which are intended for switching electronic component 6 with system alarms, these conductive wires 22 and/or the circuit board 23 also function as one of the elements of the system for detecting changes in the state of the cover 5, a part of which is located in front of the lock area 7 of the protected object in the position of the alarm device 1 when the cover 3 closes the lock area 7 of the protected object, access to which you need to open this lock. That is, if the electrically conductive wires 22 and/or the circuit board 23 are located in the cover 3 or in the movable connection 4, and if, when trying to interfere in the area 7 of the lock, by destruction/damage of the part of the cover 3 or the part of the movable connection 4 occurs, then, accordingly, and destruction/damage of electrically conductive wires 22 and/or circuit boards 23, which leads to the rupture (interruptions) of electrical circuits between electronic component 6 and an alarm system, and as a result the required alarm is activated. Such a constructive solution enhances the achievement of the technical result in terms of increasing the sensitivity of the alarm device 1 to attempts to break it or damage.

Thus, the location of a part of one of the elements of the system for detecting changes in the state of the cover 5 in front of the area 7 of the lock of the protected object leads to the fact that:
for access to area 7 of the lock or for preliminary exploration the alarm device 1 in order to “Bypass/damage/destruction/deactivation” it is always necessary to mechanically influence the cover 3 and/or the movable connection 4, at least move them in space, and as a result, there is a movement/change in the position of these elements, which leads to the triggering of the electronic component 6 and its interaction with the alarm system;
at the time of damage/destruction of any of the components of the alarm device 1 in order to “Disable/bypass/deactivate” (even if the intruder fixes the cover 3 in a stable stationary position—so that it does not moved in space) it is always first of all necessary to physically influence at least part of one of the elements of the system for detecting the change in the state of the cover 5, which is located in front of the area 7 of the lock of the protected object, that is, on part of the cover 3, or on part of the movable connection 4, or part of at least one electronic component 6 (which can be located in part of the cover 3, or in part of the movable connection 4); due to damage/destruction of a part of the cover 3, or a part of the movable connection 4 in which a part of at least one electronic component 6 is located, an open or short circuit of the electronic circuit of the alarm device 1 occurs, which leads to interaction with the signaling system; in some cases implementation the invention, damage or destruction of a part of the cover 3 itself (for example, in an alarm device 1 with an electronic component 6 as a photosensitive element 18 in the base 2) also leads to the interaction of the alarm device 1 with the alarm system.

Possibility of installing base 2 on the surface of the protected object in area 7 of the lock of the protected object, the “moving ability” of the cover 3 relative to the base 2 and relative to the area 7 of the lock of the protected object, which is carried out using a movable connection 4 between the base 2 and the cover 3, the presence of at least one electronic component 6 in the system for detecting the change in the state of the cover 5, which, when the state of the cover 3 changes interacts with the alarm system by sending a signal or by interrupting the electrical circuit “alarm device 1—alarm system”, and the fact that in the position of the alarm device 1, when the cover 3 covers the lock area 7 of the protected object, access to which is necessary to open this lock, part of at least one of the elements of the system for detecting the change in the state of cover 5 (that is, part of cover 3 or part of movable connection 4, or part of at least one electronic component 6) is located in front of the area 7 of the lock of the protected object, access to which is necessary to open this lock, allow you to achieve the rest of the technical result, namely, to increase the sensitivity of the alarm device 1 to attempts to break or damage it, or to attempts to preliminary study the type of lock of the protected object.

The design of the alarm device 1 is created in such a way that it allows it to be installed and used on various surfaces of objects of protection and also to protect area 7 of locks that are different in their configuration or other devices for accessing protected objects. The alarm device 1 is installed and fixed on the surface of, for example, doors using the base 2 (FIGS. 1, 2, 7). The base 2 can be of such a design, size and shape that allows the alarm device 1 to be installed in the area 7 of the lock in such a way that the base 2 is located in the area 7 near the lock (for example—above the lock), but not covering the lock or the slot for the lock with its own “body” (FIG. 1, 7), while the cover 3 is attached to the base 2 using a movable connection 4 with the ability to move the cover 3 relative to the base 2 for closing and opening access to area 7 of the lock of the protected object.

In some cases of implementation of the invention, the alarm device 1 can be installed directly on the surface of the door where the lock/keyhole is located—that is, in such cases, the base 2 of the alarm device 1 “covers/closes” the lock/keyhole (FIG. 2). In such cases, the base 2 contains a hole 8 (FIG. 2—FIG. 5, FIG. 8) for access to the lock of the protected object, which is made in that part of the base 2, which when installation of the alarm device 1 on the protected object, located in that area 7 of the security object lock, access to which is necessary to open this lock. In this case, the cover 3 is also attached to the base 2 by means of a movable connection 4 with the ability to move the cover 3 relative to the base 2 to close and open access to the lock. It should be noted that for this design and the location of the structure of the base 2 in the position of the alarm device 1, when the cover 3 closes the hole 8 of the base 2, part of at least one of the elements of the system for detecting the change in the state of the cover 5 (that is, part of the cover 3 or part of the movable connection 4, or part of at least one electronic component 6) is located in front of this hole 8 for access to the lock of the protected object.

It should be noted that the base 2 and the cover 3 of the alarm device 1 can have different design features that make it more convenient to install and use the device at various security objects.

The base 2 may contain holes 9 for attaching the alarm device 1 to the protected object (FIG. 2, 3). With the help of holes 9 and screws, screws and other parts, the base 2 can be attached to the protected object.

The movable connection 4 between the cover 3 and the base 2 can be made and located in different parts of the device—top, side, bottom (on FIG. 10 shows various possible configurations for the arrangement of the movable connection 4 between the cover 3 and the base 2). But the most effective is the location of the movable connection 4 in the lower part of the alarm device 1 (FIG. 1, 2, FIGS. 10.1-10.3)—it is this arrangement that provides consumers with the most convenient opening of the cover 3 “Down”, which allows the open cover 3 to freely “hang” down and not fall on top of the key while opening the lock. Also, with the “bottom” location of the movable connection 4, when the cover 3 opens downwards, it (the open cover 3) does not “rest” on the door handle or the movable handle of the lock, which in most cases are located on the doors above the lock.

Also, in some cases of implementation of the invention, for example, when the electrically conductive wires 22 are led from the electronic component 6, which is located in the cover 3, through the movable connection 4 to the base 2, the alarm device 1 may contain an element for limiting the movement of the cover 3 (FIG. 6). Limiting element 11 prevents the consumer from twisting cover 3 always in a circle in one direction, and twist the wires 22, which can lead to their destruction. Thus, in some cases, the presence of the limiting element 11 is an absolutely necessary condition for the effective operation of the alarm device 1 and to achieve the technical result. The cover 3 may contain a hole 10 for access to the lock of the guarded object (FIG. 6).

The alarm device 1 may contain a coded or mechanical, or electromagnetic, or electromechanical lock 36 (FIG. 6), which is made with ability to block the opening of the cover 3 when it is in the closed position. Such a solution, in some cases, when the alarm device 1 is made of durable materials, is intended to additionally protect the lock from physical impact and to increase the total time it takes for an intruder to enter the object. And in some cases, the presence of a code or mechanical, or electromagnetic, or electromechanical lock 36 will avoid sabotage, in a situation where the attacker periodically opens and immediately closes the cover 3 of the alarm device 1 without further intervention (which, according to the legislation of some countries, is not even considered an offense). Thus, the need to overcome even a simple/a primitive/weak lock device under the laws of most countries will be considered an offense and have legal consequences, and the activation of the alarm device 1 is guaranteed to indicate interference with criminal intent.

In order to improve the content and more accurate positioning of the cover 3 relative to the base 2 in a stationary operating state of the alarm device 1 when the cover 3 covers the area 7 or the hole 8 of the lock of the protected object, the design of the invention provides that one of the two parts of the alarm device 1, for example, the cover 3 contains at least one (first) permanent magnet 31. In this case, the other part—base 2 is also contains a second permanent magnet 32 or contains a magnetic material 33, or is partially made of a magnetic material 33, which interacts with the first 31 permanent magnet in the cover 3 (FIG. 2). And vice versa—the base 2 can contain the first permanent magnet 31, and the cover 3 contains the second permanent magnet 32 or contains a magnetic material 33, or partially made of magnetic material 33, which interacts with the first 31 permanent magnet in the base 2. That is, in the process—when the user moves/closes/guides the cover 3 to the closed position, the magnetic force direct and precisely fixes the cover 3, which makes the use of the alarm device 1 more comfortable, and the precise positioning the cover 3, in turn, allows the use of a very sensitive system for detecting changes in the position of the cover 5 without wrong (false) alarms from the system for detecting changes in the position of the cover 5 under the influence of drafts or vibrations of the doors of the object.

Thus, as part of the alarm device 1, it is possible the use of base 2 and cover 3 with various design features, which, together with all other structural components of the device, make it possible to conveniently install and use the alarm device 1 on various surfaces of various security objects with different types of locks and significantly increase the reliability and resistance to wrong (false) alarms.

A non-standard design solution of the invention is that the features of its main elements (base 2, cover 3, movable connection 4) allow as at least one electronic component 6 (which, when the state of cover 3 changes) interacts with the system alarms, use various types of sensors and devices, such as: tilt sensor 12 (meaning—mechanical or optical, or any other tilt sensor) (FIG. 2, 8, 9), gyroscope 13, accelerometer 14, gyroscope-accelerometer 15 (FIG. 3, 6), a magnetically sensitive sensor 16 “paired” with a permanent magnet 17 (FIG. 4), an electronic photosensitive element 18 (FIG. 5), flex sensor 19 (FIG. 1), but not limited to this. In this case, the indicated electronic components 6 can be installed in the cover 3, in the base 2 and in the movable connection 4. It should also be noted that combinations of the indicated electronic components 6 can be simultaneously applied as part of the alarm device 1, and their different number can also be applied (without limitation in the form of using any one sensor). In the case when the system for detecting the change in the state of the cover 5 as an electronic component 6 contains one or more tilt sensors 12, such sensors 12 are installed in the cover 3 and connected using wires 22 or using the terminals of the circuit board 23, or using a radio module 20 with alarm system. At the time of the change in the state of the cover 3, in particular in the moment its position changes, the tilt sensor 12 due to a change in its own location in space together with the cover 3, is triggered and sends a signal to the alarm system. In this case, the tilt sensors 12 are mainly functionally an element of detecting the change the state of the position of the cover 3. The use of tilt sensors 12 as part of the alarm device 1 is very effective from the point of view of:
significant sensitivity of these sensors to their “tilt” in space (depending on the initial angle of the tilt sensor 12, it may be triggered when the cover 3 is tilted starting from 5 degrees);
the ability of the tilt sensors 12 (if they Mechanical”) to work without any power source, simplifies and increases the options for connecting the alarm device 1 to the alarm system, and also makes it possible to connect to already mounted alarm systems due to the possibility of connecting the alarm device 1 to existing door sensor, which in most cases does not require power.

In the case when the system for detecting the change in the state of the cover 5 as an electronic component 6 contains a gyroscope 13 or an accelerometer 14, or a gyroscope-accelerometer 15, such sensors 13, 14, 15 are installed in the cover 3 or in a movable connection 4 between the cover 3 and the base 4, and are connected using wires 22 or using the terminals of the circuit board 23, or using a radio module 20 with an alarm system. At the moment of changing the state of the cover 3, in particular at the moment of changing its position, the gyroscope 13 or the accelerometer 14, or the gyroscope-accelerometer 15 due to a change in its own location in space together with the cover 3 or together with the movable connection 4, triggers and sends a signal to the alarm system. In this case, the sensors 13, 14, 15 are mainly functionally elements for detecting changes in the state of the position of the cover 3.

Using gyroscope 13 or accelerometer 14 or gyroscope accelerometer 15 as part of the alarm device 1 is very effective from the point of view of:
significant sensitivity of these sensors to their “change in position in space” (these sensors 13, 14, 15 are triggered when the position of the cover 3 or movable connection 4 changes by less than 0.1 degrees)
the ability of sensors 13, 14, 15 to record the slightest movement parameters, which allows these parameters to be used to identify and differentiate manipulations with the cover 3 “to open”, “to vibration” when drilling the cover 3, and “to shock” or even “to physical impact” On the door, on which the alarm device 1 is installed; an unexpected effect is precisely that in this case of the implementation of the design, the alarm system has the opportunity to identify and distinguish an attempt or fact “Opening” of the cover 3, “vibration” when drilling the cover 3, and “shock” or even “Physical impact on the doors”, on which the alarm is installed device 1.

In the case where the system for detecting the change in the state of the cover 5 contains a magnetically sensitive sensor 16 as an electronic component 6, for example, Hall effect sensors or a reed switch sensor can be used as such a magnetically sensitive sensor 16. Such magnetically sensitive sensors 16 are installed in the base 2 (inside or on the surface) and connected using wires 22 or using the terminals of the circuit board 23, or using a radio module 20 with an alarm system. In this case, at least one permanent magnet 17 is installed in the cover 3, which forms a certain magnetic field for interaction with magnetically sensitive sensor 16. At the moment of changing the state of the cover 3, in particular at the moment of changing its position, the permanent magnet 17 also changes its own position together with the cover 3 and, accordingly, there is a change in the magnitude of the magnetic field (the effect of the permanent magnet 17 on the magnetically sensitive sensor 16), on which magnetically sensitive sensor 16 reacts and sends a signal to the alarm system. The use of magnetically sensitive sensors 16 in conjunction with a permanent magnet 17 as part of the alarm device 1 is very effective from the point of view of:
significant sensitivity of the magnetically sensitive sensor 16 to changes in the magnetic field (for example, when using Hall sensors from 1000 mV/T and more);
the possibility of creating an alarm device 1 without using wires 22 between the cover 3 and the base 2, which makes it possible to increase the wear resistance of the alarm device (that is, the internal components cover 3 and base 2 do not require wiring connection in this case);
the possibility of operation of magnetically sensitive sensors 16 of the “Reed switch” type without any power source, which simplifies and increases the options for connecting the alarm device 1 to the alarm system, even to the already mounted alarm systems due to the possibility of connection alarm device 1 to an already existing and previously installed door opening sensor, which in most cases does not require power.

In the case where the system for detecting the change in the state of the cover 5 contains an electronic photosensitive element 18 as an electronic component 6, then such an electronic photosensitive element 18 is installed in the base 2 in such a way that it the photosensitive surface 29 is located to the inner plane 28 of the cover 3. In this case, the cover 3 has such an internal plane 28 that is covered with a material or made of a material or contains a material in which cracks or irregularities are formed as a result of mechanical or thermal action, or a change in the surface pattern occurs, or change light transmission. So the material of which the cover 3 or its inner plane 28 is made can be, for example, tempered glass. The inner plane 28 of the cover 3 should be located on the inner surface of the cover 3, which simultaneously covers the outer side of the base 2, electronic photosensitive element 18 and area 7 or hole 8 for access to the lock of the protected object in the condition of the alarm device 1 when the cover is closed 3. The electronic photosensitive element 18 is connected by means of wires 22 or by means of the terminals of the circuit board 23 or by means of a radio module 20 to the alarm system. At the time of the change in the state of the cover 3, for example, in the moment its position changes, the “light balance” or “light environment” in the area of the electronic photosensitive element 18 changes, and it reacts to such changes and sends a signal to the alarm system. In addition, in the case of a change in the state of the cover 3 in the form of its destruction/damage, the “light balance” or “light environment” changes in area of the electronic photosensitive element 18, and it reacts to such changes and sends a signal to the alarm system.

The use of an electronic photosensitive element 18 in together with the inner plane 28 of the cover 3 as part of the alarm device 1 is very effective from the point of view of:
significant and instantaneous sensitivity of the electronic photosensitive element 18 to change the “light balance” or “light environment” at the time of the movement or destruction of the cover 3 (“response” time from 30 microseconds);
the possibility of making an alarm device without the need for the use of wires 22 between the cover 3 and the base 2, which allows to increase the durability of the alarm device 1 (i.e. the internal components of the cover 3 and base 2 in this case do not require a wiring connection).

In the case where the system for detecting the change in the state of the cover 5 as an electronic component 6 contains a flex sensor 19, then such a flex sensor 19 in most cases, it is installed in a movable connection 4 and connected using wires 22 or using the terminals of the circuit board 23, or using a radio module 20 with an alarm system. At the moment of changing the state of the cover 3, in particular at the moment of changing its position, the movable connection 4 also changes its own position in space and possibly changes its shape (if it is “flexible”), or changes the position of the constituent components, if it is, for example, “hinge with connection”. The flex sensor 19, due to a change in its own position in space, together with the movable connection 4 and/or together with the cover 3, is triggered and sends a signal to the alarm system. Use of flex sensor 19 as part of alarm device 1 is very effective in terms of:
significant speed and sensitivity to flexing, as well as from the point of view of the ability to change its own electrical resistance in large ranges (for example, to change its own electrical resistance by half) when flexing from 1 to 90 degrees (for example, from 20 to 10 Kom when flexing the sensor 19 90 degrees).
the possibility of using thin/flat sensors, which allows to create a very thin alarm device 1 as a whole and it is convenient to install and use it at various security objects;
the ability to connect a flex sensor 19 without any source power supply, which simplifies and increases the options for connecting the alarm device 1 to the alarm system, which require a certain electrical resistance in the security loop.

The above possibilities of using various sensors and devices as an electronic component 6 in combination with all others elements of the device, with their relative position and interconnection allow to enhance and diversify the achievements of the main technical result, namely, to increase the sensitivity of the alarm device 1 to attempts to break or damage it or to attempts to preliminary study the type of lock of the protected object, and also to increase the reliability and speed of notification of an attempt unauthorized burglary, damage to the alarm device and an attempt to preliminary study the type of lock of the protected object or unauthorized burglary and/or opening the lock of the protected object by quickly sending a signal to the alarm system and/or electronic digital devices of persons observing the protected object.

In addition to the presence of at least one main electronic component 6 in the system for detecting changes in the state of the cover 5, the design of the alarm device 1 provides for the possibility of installing additional electronic components. Such a component can be a radio module 20 (FIG. 2, 8, 9), which can be made with cryptographic protection of the radio channel, and can have a self-contained battery. The radio module 20 can be installed in the cover 3 or in the base 2, and is connected to at least one electronic component 6, which, when the state of the cover 3 changes relative to the base 2, interacts with the alarm system. If the position of the cover 3 is changed or if it is damaged/destroyed, the radio module 20 receives a signal from the electronic component 6 and transmits a radio signal about a change in the state of the cover 3 to the alarm system or electronic-digital devices of persons observing the protected object. By installing and using the radio module 20 as part of the alarm device 1, it becomes possible to use the alarm device 1 without a wiring connection with the alarm system, and transmit such signals to the alarm system using radio signals (GSM, WiFi and others, but not limited to these type of radio channels). Such a constructive solution improves the achievement of the set technical task and technical result.

In some cases of implementation of the invention to at least one the electronic component 6 of the system for detecting the change in the state of the cover 5 can be connected at least one resistor 21 (or a resistor 21 of variable resistance) (FIG. 2, 6), which can be located inside the cover 3 or inside the base 2, or in a movable connection 4 between cover 3 and base 2. Resistor 21 (or resistor 21 variable resistance) allows you to connect alarm device 1 directly to those alarm systems loops, for which the “absence of alarms” is the presence in the electrical circuit of the loop of a certain electrical resistance, and the use of resistor 21 as a “regulator” of variable resistance by adjusting this particular resistor 21 of electrical resistance in the electrical circuit of the alarm system loop allows to make the alarm device 1 more versatile and convenient for installation and use at various protected objects. Also, the installation of a resistor 21 (or a resistor 21 of the min resistance) exactly in the alarm device 1 makes it possible to provide protection against attempts to overcome/bypass the signaling device 1 by manipulating its electrically conductive output (i.e. —with wires outside the alarm device).

In some cases of implementation of the invention, at least one additional magnetic sensor of the type “Reed switch” 30 (FIG. 8, 9) can be used, which can be located inside the cover 3 or inside the base 2, or in a movable connection 4 between the cover 3 and the base 2.

The use of an additional magnetically sensitive sensor of the type “reed switch” 30 allows to detect (determine) the intruder's attempts to external influence (at a distance) on the operation of the alarm device 1 (for example, when used in the device 1 as an electronic component 6 mechanical sensors 12) using a powerful magnet. The presence of a magnetically sensitive sensor of the “reed switch” type 30 improves the sensitivity of the alarm device 1 to attempts to break it.

Taking into account the presence in the composition of the alarm device 1 at least one electronic component 6 that interacts with the alarm system, and taking into account the possible presence of additional electronic elements, it is quite clear to a person skilled in this field that any electronic components of this design can be connected to the alarm system at least by an electrically conductive connection, or (as mentioned above) using radio channel (radio channels) or through the data input/output ports 40. Accordingly, in some cases of implementation of the invention, at least one electronic component 6, which, when the state of the cover 3 changes, interacts with the alarm system, can be connected to conductive wires 22 (FIG. 3) or installed on circuit board 23 (FIG. 6, 8, 9), which in turn have connections with the system alarm. At the same time, in the condition of the alarm device 1, when the cover 3 closes the area 7 of access to the lock or closes the base 2, then part of the electrically conductive wires 22 or part of the circuit board 23 inside the cover 3 and/or in the movable connection 4 become also located in front of the area 7 or in front of the hole 8 of the base 2 to access the lock of the protected object. The specified possibility of placing part of the electrically conductive wires 22 or part of the circuit board 23 in front of the area 7 or in front of the hole 8 of the base 2 for access to the lock of the protected object makes it possible to improve the achievement of the technical result in terms of increasing the sensitivity of the alarm device to attempts to break or damage it. That is, if the cover 3 or the movable connection 4 is destroyed or damaged, in which the conductive wires 22 or part of the circuit board 23 are located, the wires 22 or the board 23 are also damaged and the electrical circuits are broken, which leads to the alarm system being triggered.

The design of the alarm device 1 provides for the possibility of installing inside the base 2 or inside the cover 3 of an electric sound siren 34 (FIG. 6), which can be an additional element of the alarm signal, which is triggered separately or together with the alarm system. The electric sound siren 34 is activated as a result of the electronic component 6 of the system for detecting the change in the state of the cover 5 or regardless of the operation of the system for detecting the change in the state of the cover 5—when the alarm of the alarm system is activated by other alarm devices of the protected object.

Also, the alarm device 1 may contain an electrical switch 37 (tamper), which is installed in the base 2 (FIG. 5) and is connected to the alarm system in such a way that when the intruder removes/break away the alarm device 1 from the surface of the protected object, the electric switch 37 sends a signal to the alarm system. The presence of an electric sound siren 34 and an electric switch 37 improves the achievement of the technical result in terms of increasing the reliability and speed of notification of an attempt at unauthorized burglary, an attempt to damage the alarm device and an attempt to preliminary study the type of lock of the protected object or unauthorized burglary and/or opening the lock of the protected object.

The design of the alarm device 1 provides for the possibility of installing such additional elements inside the base 2 or inside the cover 3, as a shock and/or vibration sensor 39 (FIG. 2), the module Radio Frequency Identification or near field communication 35 (FIG. 6), biometric scanner 38 (FIG. 7), data input/output port 40 (FIG. 8, 9), microcontroller 41 (FIG. 8, 9), photo/video camera 42 (Fig. eight).

In some cases of the implementation of the invention, when the signaling device 1 additionally contains a biometric scanner 38 or a radio frequency identification or near field communication module 35, these elements can be used by users authorized deactivation of the alarm device 1 or the alarm system. Using a 38 biometric scanner or RFID module or near field communication 35 as part of the alarm device 1 is very effective from the point of view of:
authorization of the user of the device 1, which allows the use of an electronic key or smartphone to control the alarm device 1 and the alarm system;
convenience of using the alarm system—avoiding the need to open the lock and turn off the system in a strictly limited time and avoid the need to remember the password;
security, which allows the use of electronic keys with a high degree of crypto protection;
authorization speed, which makes it possible to reduce the time before the alarm is triggered by an average of 30-40 seconds (due to the absence of the usual time interval for deactivating the alarm system).

In some cases, the alarm device 1 may additionally contain at least one shock and/or vibration sensor 39 (FIG. 2), which can be located inside the cover 3 or inside the base 2, or in a movable connection 4 between the cover 3 and the base 2. The shock and/or vibration sensor 39 is triggered by physical impact (shock/vibration) on the alarm device 1 or on its elements. The shock and/or vibration sensor 39 can be one of the components of the system for detecting changes in the state of the cover 5, which upon physical impact on the cover 3, it is triggered and sends a signal to the alarm system. It should be noted that the shock and/or vibration sensor 39 can be installed, for example, inside the cover 3 as a single electronic component 6 of the system for detecting the change in the state of the cover 5, or the shock and/or vibration sensor 39 can be installed as an additional electronic component 6 of the system for detecting changes in the state of the cover 5 simultaneously with the main electronic component 6, for example, with the tilt sensor 12 (FIG. 2).

In some cases, the alarm device 1 may contain a data input/output port 40, through which the alarm device 1 can be connected to addressable alarm loops, telecommunication networks and integrated into a network access control system, smart home systems and other automated systems.

The use of data input/output port 40 as part of the alarm device 1 is very effective from the point of view of:
the ability to connect to digital networks, which allows to integrate the alarm device 1 into modern security systems and use the alarm device 1 in addressable signaling systems;
informativeness—data input/output port 40 allows more informative alarm messages to be transmitted over wired channels.

In some cases, the alarm device 1 may contain a microcontroller 41 that can process, analyze or digitize the indicators of electronic components/sensors of the alarm device 1, control the electromagnetic or electromechanical lock 36 and provide many other basic and additional functions. Usage microcontroller 41 as part of the alarm device 1 is very effective from the point of view of:
processing and analysis of internal indicators, allows you to increase reliability and differentiate false alarms, opening or an attempt to force action on the alarm device 1;
additional possibilities—the use of microcontroller 41 allows you to create an intelligent alarm device with many additional functions.

In some cases, the alarm device 1 may contain a photo/video camera 42, which can be installed inside the cover 3 or inside the base 2, and which during operation captures event that triggered alarm devices 1 had been react on and which sends pictures or video message while alarm to the electronic digital device of person that controls protected object or to video capturing systems, or storing information systems. Using a photo/video camera 42 as part of an alarm device 1 is very effective in terms of information content, and photo/video camera 42 allows to remotely determine the event that triggered the alarm device 1 and to assess in advance the degree of threat.

The presence in the design of the alarm device 1 of such additional elements as: the shock and/or vibration sensor 39, radio frequency identification or near-field communication module 35, biometric scanner 38, data input/output port 40, microcontroller 41, photo/video cameras 42 allows you to improve the achievement of the main and additional technical result—it is more convenient and efficient to use the alarm device 1 at various objects of protection.

### PRACTICAL IMPLEMENTATION

### Brief Description of the Figures

The practical implementation and industrial capability of the alarm device is explained by the schematic drawings of construction on which:

FIG. 1—alarm device 1, which is located in the area 7 of the lock of the protected object, and which contains an electronic component 6 as a flex sensor 19;

FIG. 2—alarm device 1 with base 2, which contains hole 8 for accessing the lock of the protected object, and which is located in the area 7 of the lock of the protected object, and contains electronic components 6 as a flex sensor 19 and a shock/vibration sensor 39, a radio module 20, a resistor 21, permanent magnets 31, 32 (or magnetic material 33);

FIG. 3—alarm device 1 with base 2, which contains hole 8 for access to the lock of the protected object, with an electronic component 6 as a gyroscope 13 or an accelerometer 14, or a gyroscope-accelerometer 15 with conductive wires 22;

FIG. 4—alarm device 1 with base 2, which contains a hole 8 for access to the lock of the protected object, with an electronic component 6 as magnetically sensitive sensor 16 and a permanent magnet 17;

FIG. 5—alarm device 1 with base 2, which contains a hole 8 for access to the lock of the protected object, with an electronic component 6 as an electronic photosensitive element 18 and also with an electric switch 37 (partially shown in section—the inner plane 28 of the cover 3 and the photosensitive surface 29 of the electronic photosensitive member 18);

FIG. 6—alarm device 1 in a disassembled state: base 2 and cover 3 containing hole 10, limiting element 11, gyroscope 13 or accelerometer 14, or gyroscope-accelerometer 15, resistor 21, circuit board 23, inner plane 28 of cover 3, electric sound siren 34, radio frequency identification or near-field communication module 35, lock 36;

FIG. 7—alarm device 1, which is located in the area 7 of the lock of the protected object, and which contains a biometric scanner 38;

FIG. 8—alarm device 1, in which electronic components 6 as two tilt sensors 12, that are installed on a circuit board 23, an additional magnetically sensitive sensor type of the “reed switch” type 30, a permanent magnet 31, a magnetic material 33, a radio module 20, a data input/output port 40, microcontroller 41, photo/video camera 42;

FIG. 9—the inner cavity of the cover 3 with electronic components 6 as two tilt sensors 12;

FIG. 10—shows various configurations of execution and arrangement of the movable connection 4, base 2 and cover 3 of the alarm device;

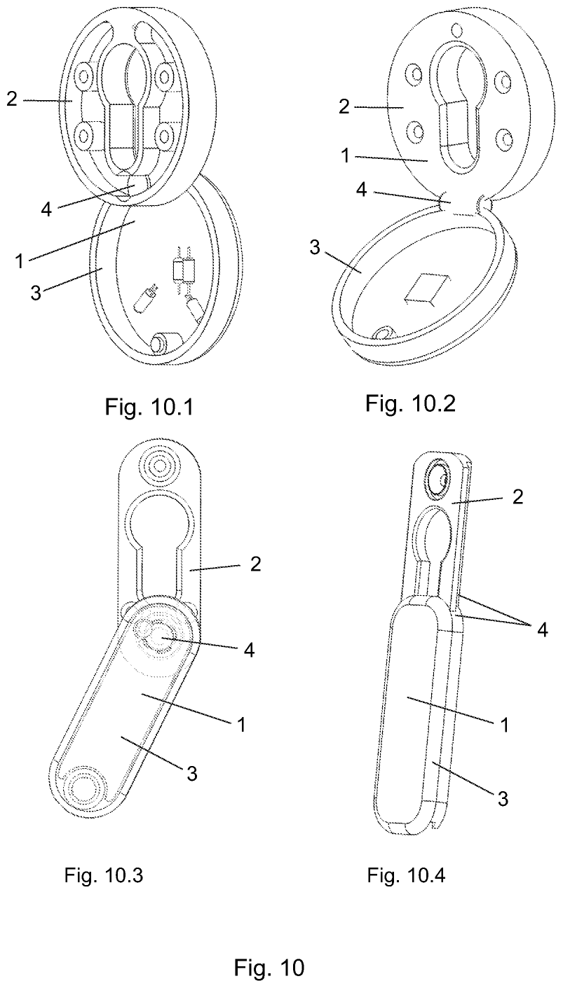

FIG. 11—alarm device 1 in a closed state.

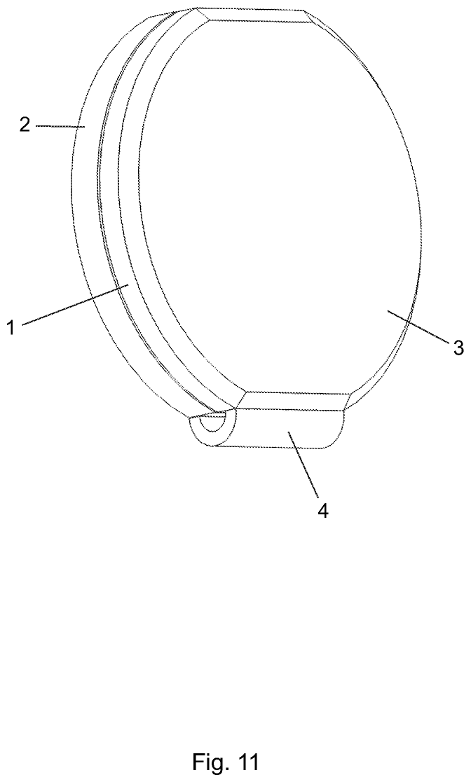

The structural elements of the invention are designated by the following reference numerals:
1—alarm device;
2—base;
3—cover;
4—movable connection between cover 3 and base 2;
5—system for detecting changes in the state of the cover;
6—electronic component of the system for detecting changes in the state of the cover 5;
7—the area of the lock of the protected object;
8—base hole 2 for access to the lock of the guarded object;
9—holes in the base 2 for attaching the alarm device 1 to the protected object;
10—hole of the cover 3 for access to the lock of the protected object;
11—limiting element for changes in the position of the cover 3;
12—tilt sensor;
13—gyroscope;
14—accelerometer;
15—gyroscope accelerometer;
16—magnetically sensitive sensor;
17—a permanent magnet for the magnetically sensitive sensor 16;
18—electronic photosensitive element;
19—flex sensor;
20—radio module;
21—resistor or resistor of variable resistance;
22—electrically conductive wires;
23—circuit board;
24—tilt sensor 12 housing;
25—unfixed ball of the tilt sensor 12;
26—a conductive liquid substance, or a liquid mixture of substances with conductive properties;
27—conductive contacts of the tilt sensor 12;
28—the inner plane of the cover 3,
29—photosensitive surface of the electronic photosensitive element 18;
30—additional magnetically sensitive sensor of the “reed switch” type;
31, 32—two permanent magnets (for cover 3 and for base 2);
33—magnetic material;
34—electric sound siren;
35—radio frequency identification or near field communication module;
36—cover lock 3;
37—electrical switch at base 2;
38—biometric scanner;
39—shock and/or vibration sensor;
40—data input/output port;
41—microcontroller;
42—photo/video camera.

### THE BEST EXAMPLE OF IMPLEMENTATION OF THE INVENTION

### Description of the Construction of the Invention

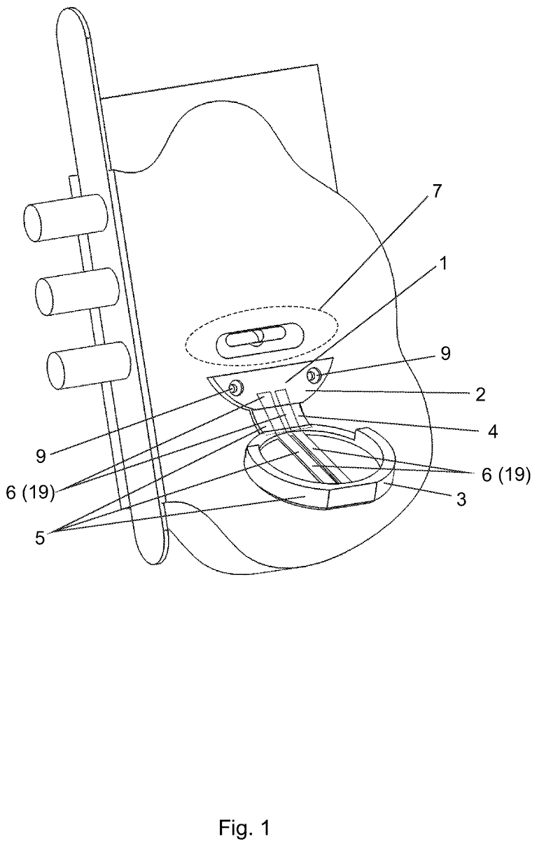

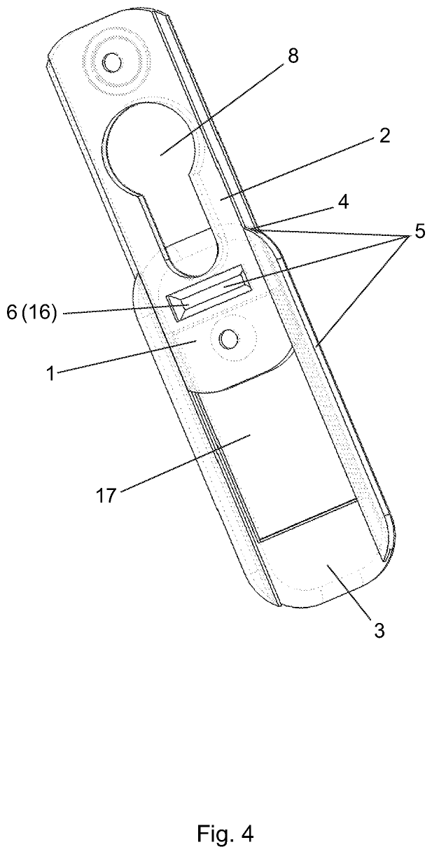

The alarm device 1 contains a base 2, a cover 3, movable connection 4 between cover 3 and base 2 and the system for detecting changes in the state of the cover 5 (FIG. 1—FIG. 5). The base 2 is made with the possibility of its installation on the surface of the protected object in the area 7 of the lock of the protected object. The protected object can be any premise, building, apartment, room, vehicle, safe, money terminal and others objects, but not limited to those listed. The surface of the protected object can be doors or other elements in which or on which any lock can be installed, which requires a certain physical access to open it. Also, the protected object can be directly the lock. The proposed Alarm device 1 can be used for the protection of various types of locks, such as mortise/invoice (key), biometric, code and others.

The cover 3 is attached to the base 2 by means of a movable connection 4 between the cover 3 and the base 2 with the possibility of moving the cover 3 relative to the base 2 to close and open access to that area 7 of the lock of the protected object, which is necessary to open this lock (FIG. 1, 2). Cover 3 and base 2 can have different shapes and sizes. Mainly, these elements—cover 3 and base 2 can be made flat and contain a certain space (cavity) inside for installing other elements and parts, such as: electronic components, wires, circuit boards, others.

To increase the reliability against attempts to break the alarm device 1, the space (cavity) of the cover 3 and/or base 2 can be filled with a solid material, for example, epoxy resin, plastic or any other such that part of the device—cover 3 or base 2 with the elements it contains, form a monolithic/integral part.

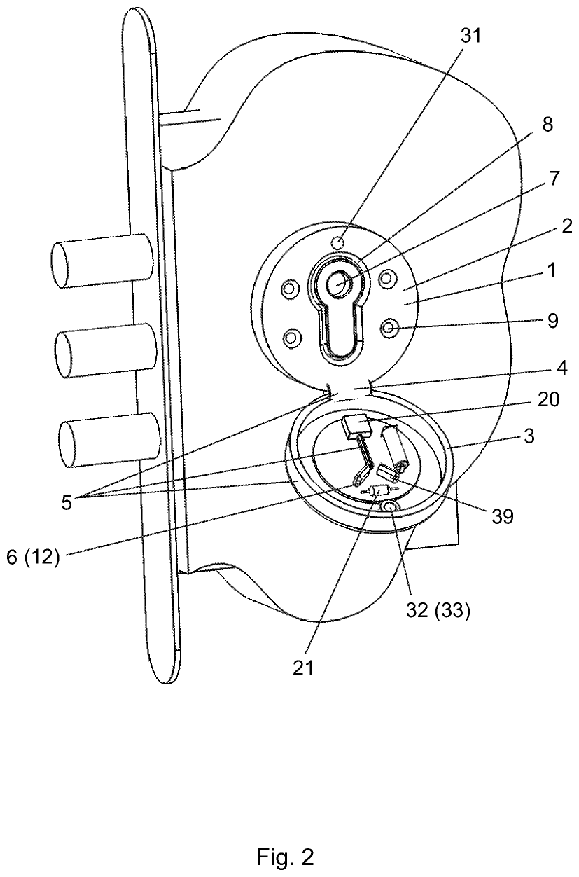

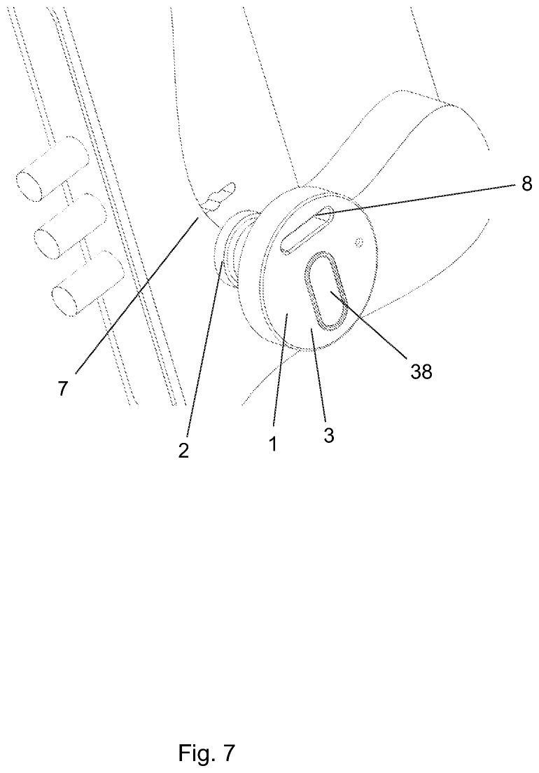

In some cases, the execution of the invention, the base 2 may contain a hole 8 (FIG. 2—FIG. 5, FIG. 7) for access to the lock of the protected object, which is made in that part of the base 2, which, when the alarm device 1 is installed on the protected object, is located in the area 7 of the lock of the protected object, access to which is necessary to open this lock. In this case, part of at least one of the elements of the system for detecting changes in the state of the cover 5 in the state of the alarm device 1, when the cover 3 closes the hole 8 of the base 2, located in front of this hole 8 for access to the lock of the protected object. In such cases, at least electronic components 6 in the form of various sensors and parts, and other structural elements that are more are carefully described below.

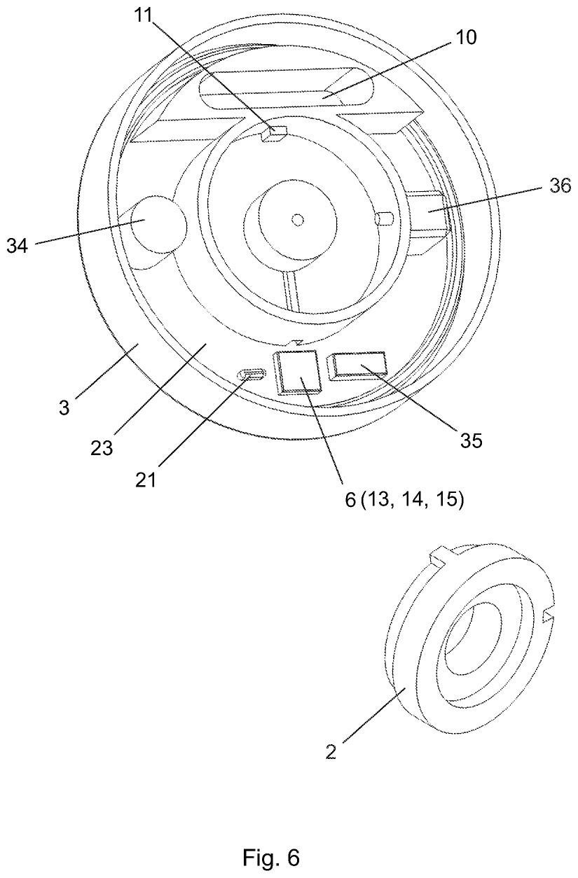

Also, in some cases of implementation of the invention:
the base 2 may contain holes 9 for attaching the alarm device 1 to the protected object (FIGS. 1, 2, 3).
cover 3 may contain hole 10 for access to the lock of protected object (FIG. 6).

In addition, in some cases of implementation of the invention, the cover 3 and/or base 2 may contain a limiting element 11 for changes in the position of the cover 3 (FIG. 6), which can be made in the form, for example, of stops, protrusions and/or corresponding grooves.

The movable connection 4 between the cover 3 and the base 2 can be made, for example, in the form of a hinge connection, but not limited to this. Movable connection 4 required for attaching cover 3 to base 2 with the possibility of relative movement within the required limits and trajectory for triggering at least one electronic component 6 (sensitive element/sensor) of the system for detecting the change in the state of the cover 5 and at the same time for the convenient use of the device. The movable connection 4 can be located in any part of the alarm device 1, but in some cases implementation of the invention, the movable connection 4 between the cover 3 and the base 2 is made and located in the lower part alarm device 1 (FIG. 1, 2) in such a way that when external mechanical action on the cover 3 (from the side of the person—the owner of the protected object or from the side of the intruder), the cover 3 moves relative to the base 2 “to the side” and “down”, or “from base 2” and “down”.

The system for detecting the change in the state of the cover 5 is formed as minimum, from cover 3, movable connection 4 between cover 3 and base 2 and at least one electronic component 6 (FIGS. 1-5), which, when the state of cover 3 changes, interacts with the alarm system (as at least one electronic component 6 various sensors, devices, parts can be used, which are described more (see details below).

In this invention, the term “alarm system” should be understood as a security, fire, centralized, autonomous electronic alarm system, an access control system, a smart home system, a software application for interacting with a device. Or “alarm system” can be located directly in the alarm device 1, or as an additional module, which can be placed, for example, inside the door or on the inside plane of the door/in a protected space.

According to the invention, part of at least one of the elements of the system detecting the change in the state of the cover 5 in the condition of the alarm device 1, when the cover 3 covers the lock area 7 of the protected object, access to which is necessary to open this lock, is located just in front of this lock area 7 of the protected object, access to which is necessary to open this lock. That is, part of the cover 3 and/or part of the movable connection 4 between the cover 3 and the base 2, and/or part of at least one electronic component 6, which are components of the system for detecting changes in the state of the cover 5, is located in front of the area 7 of the lock in such a way that to open the lock, the consumer (or an intruder) needs to interact with a minimum one element of the system detecting the change in the state of the cover 5, which in its turn leads to a desired triggering of of the system detecting the change in the state of the cover 5 and to the subsequent direction signal to the alarm system and/or digital electronic devices of the observer person of the protected object of (for a detailed description of the device given below).

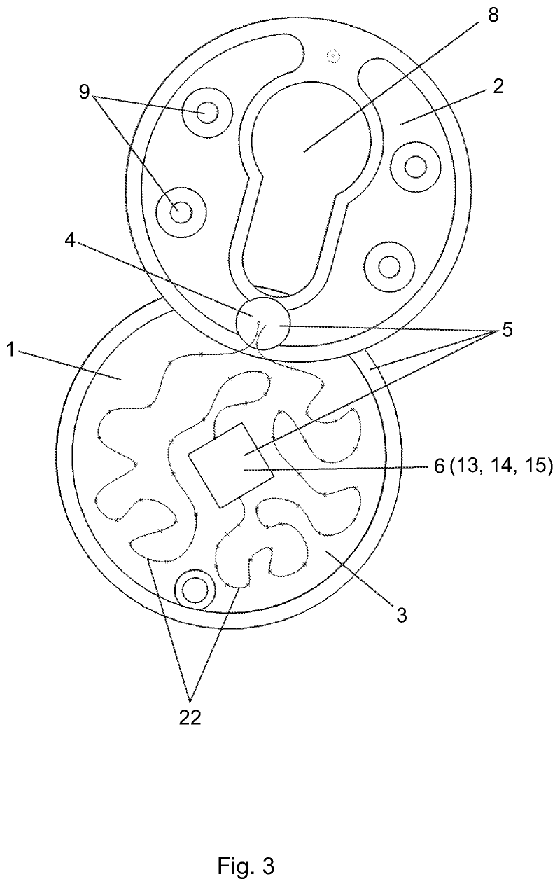

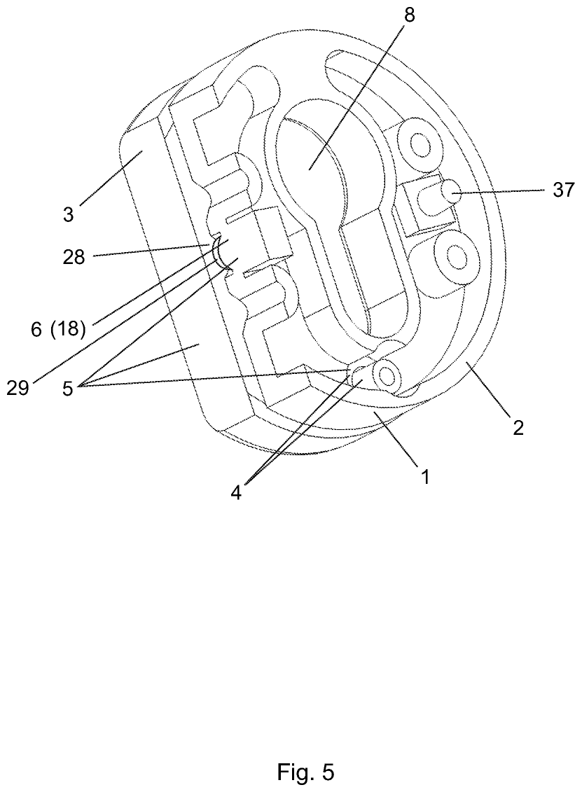

In some cases, implementation of the construction of the invention, as an at least one electronic component 6 of the system for detecting change in the state of cover 5 in alarm devices 1 can be installed and used: at least one tilt sensor 12 or a mechanical tilt sensor 12 (FIGS. 2, 8, 9.) or at least one gyroscope 13 (FIG. 3, 6), or an accelerometer 14 (FIG. 3, 6), or a gyroscope-accelerometer 15 (FIG. 3.6), or at least one magnetically sensitive sensor 16 (FIG. 4), or at least one electronic photosensitive element 18 (FIG. 5), or at least one flex sensor 19 (FIG. 1). In addition, together with the already mentioned components 12, 13, 14, 15, 16, 18, 19, as additional electronic components 6 of the system for detecting the change in the state of the cover 5 or alarm device 1 can be installed and applied: a radio module 20 (FIG. 2, 8, 9) or a radio module with cryptographic protection of the radio channel, an autonomous battery and/or a resistor 21 (FIG. 2, 6), or a resistor 21 of variable resistance. And also all the above possible electronic components 6 of the system for detecting the change in the state of the cover 5 (12, 13, 14, 15, 16, 18, 19, 20, 21), which, when the state of the cover 3 changes, interact with the alarm system, in various individual cases can be connected to each other or to the alarm system with electrically conductive wires 22 (FIG. 3) and/or they can be installed on the circuit board 23 (FIG. 6, 8, 9) (which can also be connected to the alarm system), and at least one electronic component 6 of the system for changing the state of the cover 5 of the alarm device 1 can be connected to the alarm system by wires 22, either directly or via the microcontroller 41 or via additional electronic components or using a radio module 20 via a radio channel/a radio channel with cryptographic protection or using the data input/output port 40 via electronic digital networks.

It should be noted that in cases of use, in the alarm device 1 the electrically conductive wires 22 and/or the circuit board 23, part of these electrically conductive wires 22 or part of the circuit board 23 in position, when the cover 3 covers the base 2, is located inside the cover 3 and/or in a movable connection 4 in front of the hole 8 of the base 2 for access to the lock of the protected object. In some cases, to increase the protection of the alarm device 1 from attempts to drill or saw off parts of the alarm device 1, wires 22 and/or electrically conductive tracks of the circuit board 23 can form a mesh structure or be distributed in space inside: base 2 and/or movable connection 4, and/or cover 3 in such a way as to “cover” the maximum area (FIG. 3).

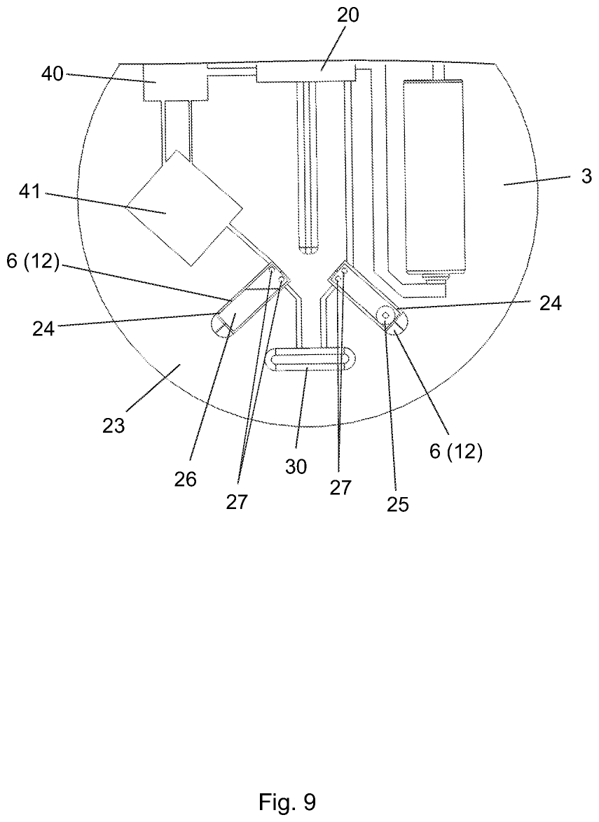

In cases where the system for detecting the change in the state of the cover 5 is formed at least from the cover 3, a movable connection 4 between cover 3 and base 2, and an electronic component 6 as at least one tilt sensor 12 (mechanical, optical, other), this tilt sensor 12 is located inside the cover 3 (FIGS. 2, 8, 9). The alarm device 1 can be used, for example, a mechanical tilt sensor 12, which contains a housing 24, inside which is located at least one unfixed ball 25 with a conductive surface or a conductive liquid substance 26 or a liquid mixture of substances with a conductive property (FIG. 9). And inside the housing 24 of the mechanical tilt sensor 12, at least two conductive contacts 27 are connected to enable this mechanical tilt sensor 12 to be connected to the system signaling the protected object (FIG. 9). It should be noted that two or more mechanical tilt sensors 12 (the same or different) can be located in the cover 3. The design of the mechanical tilt sensor 12, the principle of its operation, is that when the cover 3 moves relative to the base 2, the mechanical tilt sensor 12 interacts with the alarm system.

Also, in some cases, any other tilt sensors 12 can be used, for example, optical, in which the ball rolls in the sensor housing and interrupts the light beam from the LED to the photodiode. In this invention, the term “tilt sensor 12” should be understood as any sensor that is affected by its rotation in space (change in the angle of its position): mechanical tilt sensor, liquid tilt sensor, mercury tilt sensor, optical tilt sensor and others. Tilt sensors 12 are mainly functionally elements for detecting changes in the state of the position of the cover.

In cases where the system for detecting the change in the state of the cover 5 formed at least from cover 3, movable connection 4 between cover 3 and base 2, and at least one of the electronic component 6 as at least one gyroscope 13 or as an accelerometer 14, or as a gyroscope-accelerometer 15 (FIG. 3, 6), one of these devices 13, 14, 15 is located inside the cover 3 or in the movable connection 4 between the cover 3 and base 2. The design of the gyroscope 13 and the accelerometer 14 and the gyroscope-accelerometer 15, the principle of their operation, provide that when the cover 3 moves relative to the base 2, the gyroscope 13 or the accelerometer 14 or the gyroscope-accelerometer 15 interacts with the alarm system. That is, at the time of the change in the state of the cover 3, in particular, at the time of its change position gyroscope 13 or accelerometer 14 or gyroscope accelerometer 15 due to a change in its own position in space together with the cover 3 or together with the movable connection 4, is triggered and sends a signal to the alarm system. Sensors 13, 14, 15 are mainly functionally elements detecting the change in position of cover 3.

In some cases implementation of the alarm device 1, the system for detecting the change in the state of the cover 5 is formed, at least from the cover 3, inside which there is at least one permanent magnet 17, from the movable connection 4 between the cover 3 and the base 2, at least from one electronic component 6 as at least one magnetically sensitive sensor 16 (FIG. 4). Magnetically sensitive sensor 16 is located in the base 2 and is configured to be connected to the alarm system of the protected object. The permanent magnet 17 is installed in the middle of the cover 3 in such a way that in the state of the alarm device 1, when the cover 3 closes area 7 of the lock of the protected object, access to which is necessary to open this lock, or when the cover 3 closes the hole 8 of the base 2, then the permanent magnet 17 (or part of it) in the cover 3 is located in the area of operation of the magnetically sensitive sensor 16. The design of the magnetically sensitive sensor 16 principle his works provide that when moving cover 3 (together with the permanent magnet 17) relative to the base 2, the magnetically sensitive sensor 16 interacts with the permanent magnet 17 (the parameters of the magnetic field in the region of the magnetically sensitive sensor 16 are changed) and, as a consequence, the magnetically sensitive sensor 16 interacts with the alarm system, sending it a signal. In this invention under “Magnetically sensitive sensor 16” should be understood as a sensor that switches electrically conductive contacts, for example, a reed switch in the presence of a certain magnetic field or sensors that work on the basis of the Hall effect, for example, a Hall sensor, magnetic encoder, magnetically resistive and any other sensors that react to a change, absence or appearance of a magnetic field.

In other individual cases of the implementation of the alarm device 1, the system for detecting the change in the state of the cover 5 is formed at least from the cover 3, from the movable connection 4 between the cover 3 and the base 2, from at least one electronic component 6 as at least one electronic photosensitive element 18 (FIG. 5). In such cases, the cover 3 contains such an internal plane 28 (FIG. 5), which can contain material or be covered with a material, or is made of a material in which cracks or irregularities are formed as a result of mechanical or thermal action, or a change in the pattern or a change in light transmission, for example, this material can be tempered glass or fiber optic.

The electronic photosensitive element 18 is installed in the base 2 in such a way that its photosensitive surface 29 is located to the inner plane 28 of the cover 3. The inner plane 28 of the cover 3 is located on the inner surface of the cover 3. And in the state of the alarm device 1 with the cover 3 closed, the cover 3 with its inner plane 28 simultaneously covers the outer side of the base 2, the electronic photosensitive element 18 and the hole 8 for accessing the lock of the protected object. The electronic photosensitive element 18 is configured to be connected to the alarm system of protected object. Electronic design of the photosensitive element 18, the principle of its operation and the place and feature of its installation in the base 2 (when the photosensitive surface 29 is located to the inner plane 28 of the cover 3) provide that when the cover 3 moves relative to the base 2 or when the cover 3 is damaged or destroyed, the electronic photosensitive element 18 interacts with alarm system. In this invention, the term “photosensitive element 18” should be understood as any electronic photosensitive element, for example, a photodiode, photoresistor, photocell, phototransistor, optocoupler and others, or several photosensitive elements can be used, an array or matrix of photosensitive elements, for example, a CCD or CMOS sensor, optical computer mouse sensor. Additionally, the alarm device 1 may contain in the cover 3 or in the base 2 a light source, an optical fiber, an optical fiber, an optical system, or a combination thereof.

The system for detecting the change in the state of the cover 5 in some cases can be formed, at least, from the cover 3, the movable connection 4 between the cover 3 and the base 2, and at least one electronic component 6, which is made as at least one flex sensor 19 (FIG. 1). In such cases, the flex sensor 19 can be fully or partially located in the movable connection 4. Also, the flex sensor 19 is configured to be connected to the alarm system of the protected object, and the design of the flex sensor 19, the principle of its operation and the place and peculiarity of its installation in the movable connection 4 provide that when the cover 3 moves relative to the base 2, the flex sensor 19, respectively, flexes in the movable connection 4, and, as a consequence, the alarm device 1 is triggered and it interacts with the alarm system.

In other individual cases of the invention, the alarm device 1 additionally contains a radio module 20 or a radio module with cryptographic protection of the radio channel, which can be installed inside the cover 3 or inside the base 2 (FIGS. 2, 8, 9). Radio module 20 is connected with at least one electronic component 6 of the system for detecting the change in the state of the cover 5, which, when the state of the cover 3 changes, interacts with the alarm system. The electronic component 6, which is connected to the radio module 20, can be at least one tilt sensor 12 or a mechanical tilt sensor 12 (FIGS. 2, 8, 9), or at least one gyroscope 13 (FIG. 3), or accelerometer 14 (FIG. 3), or gyroscope-accelerometer 15 (FIG. 3), or at least one magnetically sensitive sensor 16 (FIG. 4), or at least one electronic photosensitive element 18 (FIG. 5), or at least one flex sensor 19 (FIG. 2). The design of the radio module 20 is made with the possibility of transmitting a radio signal about a change conditions of cover 3 to the alarm system or to electronic-digital devices of persons observing the protected object. Also, with the help of the radio module 20, radio signals can be exchanged between the alarm device 1 and the alarm system. In this invention, under the radio module 20 or radio module 20 with cryptographic protection of radio channel should be understood as a radio module of any standard and radio signal format, for example, WIFI, GSM, 3G and others.

In addition, in some cases the implementation of the alarm device 1 to the electronic component 6 of the system for detecting the change in the state of the cover 5, which, when the cover 3 moves relative to the base 2 interacts with the alarm system, can be connected at least one resistor 21 (FIG. 2, 6) or a variable resistance resistor. Resistor 21 (or variable resistor) can be located inside the cover 3 or inside the base 2, or in a movable connection 4 between the cover 3 and the base 2.

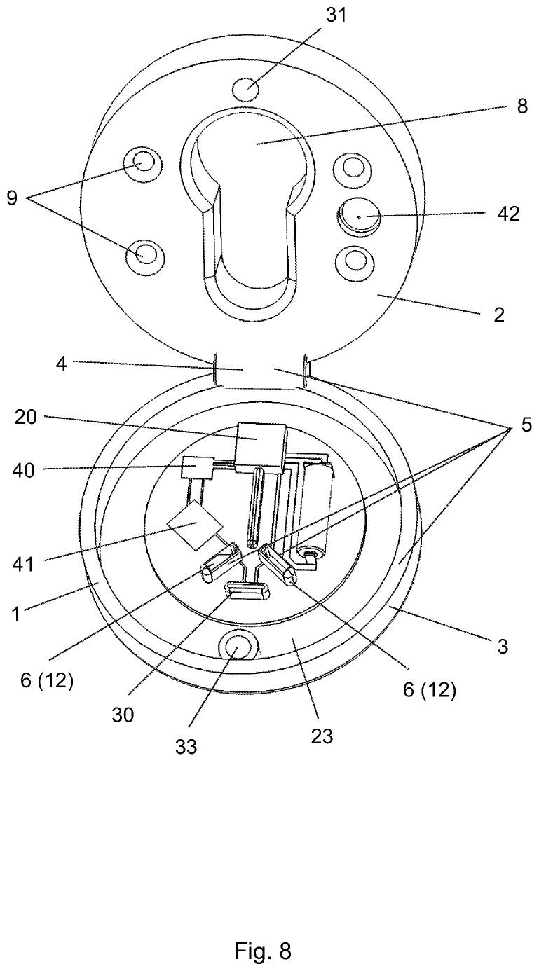

Also, in some cases of the implementation of the alarm device 1 to the electronic component 6 of the system for detecting the change in the state of the cover 5, which, when the state of the cover 3 changes, interacts with the alarm system, at least one additional magnetically sensitive sensor of the “reed” type 30 can be connected (FIG. 8, 9). This magnetically sensitive sensor of the “reed” type 30 can be located inside cover 3 or inside the base 2, or in a movable connection 4 between the cover 3 and the base 2. The magnetically sensitive sensor of the “reed” type 30 is configured to operate—open or close the electrical circuit of the electronic components of the alarm device 1 when an external permanent magnet approaches the alarm device 1 at a distance of 300 mm to 0.1 mm, or at full contact of an external permanent magnet with the alarm device 1.

In some cases of implementation of the invention, at least one of the two parts of alarm device 1—cover 3 and/or base 2 may contain at least one (first) permanent magnet 31. If this first permanent magnet 31 is installed in cover 3, then another part of the alarm device 1 (base 2) also contains a second permanent magnet 32 or contains magnetic material 33, or is partially made of magnetic material 33, which cooperate with the first permanent magnet 31 of the cover 3 (FIG. 2, 8). Accordingly, and vice versa, if the first permanent magnet 31 is installed in the base 2, then the cover 3 may also contain magnetic material 33, or may be partially made of magnetic material 33, may contain a second permanent magnet 32, which cooperate with the first permanent magnet 31 of the base 2. in such cases, the alarm device 1 is configured to fix the cover 3 to the base 2 using permanent magnets 31, 32 and magnetic material 33 (their magnetic force) in the position of the alarm device 1 when the cover 3 closes the hole 8 of the base 2).

In some cases of the invention, the alarm device 1 additionally contains an electric sound siren 34 installed inside the base 2 or inside the cover 3 (FIG. 6). The electric sound siren 34 can be connected and interact with the electronic component 6 of the system for detecting the change in the state of the cover 5 and at the time of the change the state of the cover 3, the electric sound siren 34 plays an audible alarm signal, and in other cases the electric sound siren 34 can be connected to and directly interact with the alarm system and play an audible alarm signal upon its signal/command.

The construction of the alarm device 1 can also optionally contain code, mechanical, electromagnetic or electromechanical lock 36 (FIG. 6), which is configured to block the opening of the cover 3 when it is in the closed position.

In some cases the invention, the alarm device 1 may contain a radio frequency identification or communication module the near field 35, which can be installed inside the base 2 or inside the cover 3 (FIG. 6) and can be connected to the system for detecting the change in the state of the cover 5 or to an alarm system or access control system, or connected to an electromagnetic or electromechanical lock 36.

In some cases, the implementation of the invention, the alarm device 1 contains a biometric scanner 38, which can be located in the cover 3 (FIG. 7) or in the base 2 and can be connected to the system for detecting the change in the state of the cover 5 or to the alarm system, or to the access control system, or connected to an electromagnetic or electromechanical lock 36.

In some cases, the alarm device 1 can additionally contains an electrical switch 37 (FIG. 5), which is installed in the base 2 in such a way that in the position when the alarm device is “mounted on” or “attached to” surface of the protected object, this surface of the object holds the electrical switch 37 in a closed or open position/state, and in case of unauthorized dismount/removal of the alarm device 1 from the surface of the protected object, the electrical switch 37 changes its state to the opposite and interacts with the alarm system.

In some cases, the alarm device 1 may additionally contain at least one shock and/or vibration sensor 39 (FIG. 2), which can be located inside the cover 3 or inside the base 2, or in a movable connection 4 between the cover 3 and the base 2. Sensor shock and/or vibration 39 is configured to be triggered by physical impact (shock/vibration) for alarm device 1 or its elements, in including the cover 3.

Also, in some cases, the alarm device 1 may additionally contain at least one data input/output port 40 (FIG. 8, 9), which can be located inside the cover 3 or inside the base 2. Data input/output port 40 is configured to transmit information between alarm device 1 and alarm systems, access control systems, smart home systems, other automation systems and devices, both directly and via telecommunication networks.

Thus, alarm device 1, for example, can be connected to an addressable signaling loop, to a computer network or to another device with an appropriate input/output port, for example, an rs-485 interface, ethernet or any other.

In some cases of implementation of the invention, the alarm device 1 may additionally comprise at least one microcontroller 41 (FIG. 8, 9), which can be located inside the cover 3 or inside the base 2. The microcontroller 41 is a device that is configured to process or analyze the indicators of sensors (state of electronic components) of the alarm device 1, generate digital signals and exchange them, control of electromagnetic or an electromechanical lock 36, control of the radio module 20 for interacting with alarm systems or electronic computing devices, recording an event log and for performing other additional functions.

In some cases, the alarm device 1 can additionally contain at least one photo/video camera 42 (FIG. 8), which can be located inside the cover 3 or inside the base 2. The photo/video camera 42 is made with the ability to take photo and/or video recording, and the photo/video camera 42 can be made with the ability to broadcast a photo or video message to the electronic devices of observers of the protected object or videosurvailance system or the system storage. In this invention, “photo/video camera 42” should be understood as, but not limited to, analog, digital or network photo or video camera.

In some cases, the embodiment and implementation of the invention the alarm device 1 can be made in the form of a door hardware element, be combined with a door handle. Also, the alarm device 1 can be made in the form of an armored protector of the lock, for example—in the form of an armored cover protector and/or alarm device 1 can be made of materials from which to produce armor protective fittings and have appropriate protective properties, be resistant to mechanical burglary.

The construction of the alarm device 1, together with all the main essential structural elements that are given in the claims, may also additionally contain: display elements, a keypad for entering a code, an autonomous battery for autonomous operation, electronic memory for storing “events” of the alarm device 1, additional electronic components or electronic circuits that add more functionality to the alarm device 1 or improve the result of its operation.

Description of the structure of the alarm device 1 in this invention is not restrictive. In this alarm device 1 and in some cases of its implementation, any other improvements and electronic components that are obvious to a person skilled in this field can be used, any of the elements or design solutions that are in the additional claims in any combination.

### Description of the Operation of the Alarm Device

The alarm device 1 is used mainly in conjunction with a variety of alarm systems that are used to protect various objects, including premises, buildings, apartments, rooms, vehicles, safes, money terminals, and other objects of protection.

The alarm device 1 is installed on various surfaces—such as covers, doors (FIGS. 1, 2), others that provide for a lock or other device for opening/closing a protected object or other access to security objects. The alarm device 1 is installed in the area 7 of the lock of the protected object (FIG. 1), or directly on the keyhole/slot (FIG. 2), depending on the design features of the alarm device 1.

The alarm device 1 operates as follows. The base 2 is attached to the surface plane of the protected object in the area 7 of the lock (or directly to the lock), to which the cover 3 is connected by means of a movable connection 4. Alarm device 1 contains at least one electronic component 6 that interacts with the alarm system. That is, when installing the alarm device 1, such at least one electronic component 6 is connected to the alarm system by a wired connection or in some cases using a radio module 20 or using a data input/output port 40 (FIGS. 8, 9).

The cover 3 in a static state covers that area 7 of the lock, and in some cases the hole 8 of the base 2, which are necessary to open this lock. To access the lock of the protected object, an authorized user of the protected object or an intruder must move cover 3 from area 7 the lock or in some cases from the hole 8 of the base 2—that is, they must physically open access to the lock. Sometimes intruders may not push/move the cover 3, but attempt to physically destroy/damage it, disconnect from the alarm system, or attempt to electronically or magnetically influence the alarm device 1 as a whole or into its individual components.

Accordingly, at the moment of mooving of the cover 3, this cover 3 changes its state, namely, it changes its static position in space, also the cover 3 changes its static position relative to the base 2. Also, at the time of an attempt to destroy/damage the alarm device 1 (and its components), first of all, the cover 3 can also change its state, for example, position or static position, and, simultaneously with the destruction/damage of the outer parts of the alarm device 1 and/or cover 3, and/or base 2, and/or movable connection 4, a large the likelihood of damage also to their internal elements and components. Especially it should be noted that at the moment of any attempt to gain unauthorized access to the area 7 of the lock, the first element of “contact” and “influence” is the cover 3, which in most such cases at least changes its state by changing the static position.

The construction of the invention provides that the alarm device 1 contains a system for detecting the change in the state of the cover 5, which is formed from the cover 3, the movable connection 4 between the cover 3 and the base 2, and from at least one electronic component 6, which, when the state of the cover 3 changes, interacts with the alarm system. That is, the electronic component 6 is connected (by wires or by communication via the radio module 20 or communication through the data input/output port 40) with the alarm system in such a way that with any change in the state of the cover 3, including when it is moved, damaged, destroyed, the electronic component 6 is triggered and sends a signal to the alarm system (or interrupts the established communication with the system alarm). Accordingly, the alarm is triggered at the moment even before intruder's intervention in the lock or in another device that is protected the proposed alarm device 1, which significantly reduces the time interval/interval in which an attacker can, without triggering the alarm system, perform actions to break in and open the protected object and get on it/into it.

The invention also provides that part of at least one of the elements of the system for detecting the change in the state of the cover 5 (meaning part: cover 3, movable connection 4 between cover 3 and base 2; at least one electronic component 6) in the condition of the alarm device 1 when cover 3 covers the area 7 of the lock of the protected object, or closes the hole 8 of the base 2 (access to which is necessary to open this lock) is located just in front of this area 7 or in front of the hole 8 of the base 2 of the lock of the protected object.

If an intruder opens the cover 3 to access the hole 8 of the base 2 and in the area 7 of the lock of the protected object, then he changes the state of position of cover 3.

If, in order to prevent a change in the position of the cover 3, the intruder does not open the cover 3 and does not change the state of its position in space, but drills the cover 3 or tries to saw off the part of the cover 3, which is located in front of the area 7 or in front of the hole 8 of the base of the lock of the protected object, then it changes the integrity state of cover 3, which for an attacker is necessary to open the lock of the protected object. And in such cases (when changing the position, in case of destruction, damage to the cover 3) due to the work of the construction of the invention, one of the sequences of actions (provided for by the operation of the alarm device 1) occurs, depending on the use of various types of electronic components 6 and their combination with other elements and modules. The following describes the operation and sequences of actions of the alarm device 1 with different types of electronic components 6 and under different conditions of changing the state of the cover 3.

In cases where in the system for detecting the change in the state of the cover 5 as at least one electronic component 6 is used a tilt sensor 12 or mechanical tilt sensor 12 or gyroscope 13 or accelerometer 14 or gyroscope-accelerometer 15, when an attacker opens cover 3, he changes its state—that is, changes its position in space. When the position of the cover 3 changes, these sensors 12, 13, 14, 15 also change their position due to the fact that these elements are located in the cover 3. Or when the intruder does not open cover 3, but damages or destroys it, that is changes the state of its integrity, then damage to the cover 3 occurs together with damage to one of these electronic components 6 (12 13, 14, 15) due to the fact that these elements are located in the cover 3 just in front of the area 7 or hole 8 of the base 2 with the closed cover 3. As a result of the change position and/or destruction, damage to the cover 3, the electronic component 6 as one of the described sensors 12, 13, 14, 15 is triggered and initiates turning the alarm device 1 to the alarm state, that is, the alarm device 1 is triggered.

In the case of use in the system for detecting the change in the state of the cover 5 such electronic component 6 as a magnetically sensitive sensor 16 “in pair” with a permanent magnet 17, when an attacker opens cover 3, he changes cover 3 state—changes its position in space, and the permanent magnet 17 also changes its position due to the fact that it is located in cover 3. Or when the intruder does not open cover 3, but damages or destroys it, then if it changes the state of its integrity, then this damage/destruction occurs together with damage/destruction of the permanent magnet 17 due to the fact that it is located in the cover 3 just in front of the area 7 or hole 8 of the base 2 with closed cover 3. Moreover, the permanent magnet 17, when damage/destruction changes the parameters of the magnetic field, and the magnetically sensitive sensor 16 reacts to this, thereby initiating the transition of the alarm device to the alarm state, that is, the alarm device 1 is triggered.

In the case of using such electronic component 6 as an electronic photosensitive element 18 and if the cover 3 contains an inner surface 28 made of a material that, under the influence of physical impact, changes its light-conducting/light-transmitting or reflective state (for example, as such a material can be tempered glass), when an intruder opens the cover 3, then he changes its state—that is, changes cover 3 position in space, and in such the position of the inner surface 28 also changes. Or, when the intruder does not open the cover 3 and damages/destroys it, that is, changes the state of its integrity together with the inner surface 28, this leads to a change in the light balance in front of the photosensitive surface 29 (FIG. 5) of the electronic photosensitive element 18, this action reacts electronic photosensitive element 18, and initiates the transition alarm device into alarm state, that is, alarm device 1 is triggered.

In the case of using as an electronic component 6 a flex sensor 19 in the system for detecting the change in the state of the cover 5, when an intruder opens the cover 3, then it changes its state, namely changes the position of the cover 3 and the state of the movable connection 4. That is, the shape of the movable connection 4 changes (for example, if the movable connection 4 is flexible), or the relative position of the parts of the movable connection 4 changes (for example, if movable connection 4 is swivel). If the attacker does not open cover 3, but damages it—that is, it changes the state of its integrity and together with the integrity of the flex sensor 19 (due to the fact that part of the flex sensor 19 is located in the movable connection 4, and part of the flex sensor 19 in the cover 3 in front of the area 7 and the hole 8, or it is the movable connection 4 that is partially located in front of the area 7 and the hole 8 with the cover closed 3) this leads to a change in the indicators of the flex sensor 19 (for example, the electrical resistance changes, which, when changed, goes beyond the resistance, the presence of which the alarm system considers “the absence of an alarm signal”). As a result of a change in position and/or destruction, damage to the cover 3 and/or the movable connection 4, the flex sensor 19 is triggered and the transition is initiated alarm device 1 into an alarm state, that is, alarm device 1 is triggered.

In cases of use and placement in such elements of the alarm device 1 as base 2, movable connection 4 or cover 3 of additional electronic components, such as:
resistor 21 or resistor of variable resistance, which in turn provides electrical resistance, the presence of which the alarm system considers as the absence of an alarm signal;
or a magnetically sensitive sensor of the “reed switch” type 30 (FIG. 8, 9), which in turn is triggered when an intruder tries to influence mechanical sensors of the alarm device with a permanent magnet;
or parts of wires 22 (FIG. 3) or circuit board 23 (FIGS. 6, 8, 9), which in turn combine the electronic components of the sensors or are separately connected to the alarm and partially fill the space of the elements of the alarm device 1;
or a shock and/or vibration sensor 39, which in turn is triggered when an intruder by force affects the doors or the alarm device 1; all of these specified electronic components are most likely to be damaged when an intruder does not open the cover 3, damages it, that is, changes the state of its integrity or damages another part of the alarm device 1, which contains the above electronic components, which leads to the transition of the alarm device 1 to the alarm state. That is, as a result of damage/destruction of the cover 3 (or the alarm device 1) together with the above-described components the alarm device 1 is triggered.

In the case of using an electrical switch 37 (which is also called a “tamper”) as part of the alarm device 1, when an intruder applies force to remove the alarm device 1 from the doors of the protected object, the electrical switch 37 opens or closes certain contacts (depending on their previous position), which leads to the transition of the alarm device to the alarm state, that is, the alarm device 1 is triggered.

Alarm device 1, upon transition to the alarm state (triggered) interacts with the alarm system and initiates its transition in the alarm state, and in the case of additional components in the device 1, the controller 41 records and processes changes in the state of the electronic component 6, activates the recording by the photo/video camera 42 of the message with photo or video confirmation and information about the probable cause of the alarm and sends this data via radio module 20 (for example 3G standard) or via data input/output port 40 (for example, via Ethernet) via a telecommunication network to the electronic digital devices of persons observing the protected object. If there is an electric sound siren 34 in the alarm device 1, at the time of a change in the state of the cover 3 or at the time of damage/destruction of some of the above of the internal components of the alarm device 1, the system for detecting the change in the state of the cover 5 activates the electric sound siren 34, and an alarm sounds from it.

Thus, the design features of the alarm device 1 provide an opportunity for its installation and use at the protected object. in such a way that the area 7 of the lock is always protected.

The alarm device 1, which is installed in the protected object, is activated as follows. The user activates the alarm system and, within the allotted time delay (usually 30-40 seconds), closes the lock of the protected object and the cover 3, which is precisely and reliably fixed by means of permanent magnets 31 and 32 or permanent magnet 31 and magnetic material 33 of cover 3 and base 2 (in the case of permanent magnets 31 and 32, magnetic material 33). If the alarm device 1 is made without permanent magnets 31 and 32, magnetic material 33, then the cover 3 may not be “rigidly” fixed to the base 2, but simply “close” the area of the lock with it, and the movable connection 4 holds the cover 3 in the closed position.

In cases where the cover 3 or base 2 contains a biometric scanner 38 or an RFID or near-field communication module 35, before opening the cover 3, an authorized user applies a finger to the biometric scanner 38 or puts an RFID tag to radio frequency identification module or brings an NFC-enabled smartphone to the near-field communication module 35. The alarm system will ignore the activation of the alarm device 1 or the alarm device 1 will ignore the activation of the system for detecting the change the state of the cover 5, and in the presence of an electromagnetic or electromechanical lock, the microcontroller 41 will open this lock, which unlocks the opening of the cover 3, which, in the case of placing the movable connection 4 at the bottom, moves down until it is limited by the limiting element 11 (for example, to the stop), cover 3 will not interfere with the user and makes opening the lock of the protected object convenient.

Thus, the design of the alarm device 1 allows use as an electronic component 6 as part of the system for detecting a change in the state of the cover 5 various sensors and devices used to “activate” the alarm device 1 due to a change in the state of the cover 3 (change in position, destruction, damage) or as a result of destruction, damage to other external and internal components alarm device 1. Such design possibilities significantly improve and diversify the operation of the device and improve the achievement of the technical result.

Also, the design of the alarm device 1 allows you to place and use in the details of the device various additional electronic and mechanical parts and components, also allows you to strengthen and improve the achievement of the technical result.

In general, the totality of all essential structural elements of the alarm device 1 allows you to effectively use this device for the protection of various objects, including premises, buildings, apartments, rooms, vehicles, safes, money terminals and others. And all the features of this invention make it possible to increase the sensitivity of the alarm device to attempts to break or damage it, or to attempts to preliminary study the type of lock of the protected object, and also to increase reliability and speed of notification of an unauthorized burglary attempt, damage to the alarm device 1 and an attempt to preliminary study the type of lock of the protected object or unauthorized burglary and/or opening the lock of the protected object.

### INDUSTRIAL APPLICABILITY

The proposed alarm device has passed extensive tests during its industrial production, as well as during its operation at various protected objects and together with various types of locks.

The test results showed that the design of the proposed invention allows you to create an alarm device that, during its operation, due to the totality of all essential features, allows to achieve a technical result during its use at various protected objects.

An example of a specific industrial implementation of the invention, its use is given above as the best example of implementation.

The proposed alarm device meets all the requirements for its operation, application and generally accepted safety rules for the operation of such devices.

1. An alarm device (1) consisting of a base (2), a cover (3), a movable connection (4) between the cover (3) and the base (2), and elements for detecting changes in the position of the cover, while the base (2) is made with the possibility of its installation on the surface of the protected object in the area (7) of the lock of the protected object, and the cover (3) is attached to the base (2) by means of a movable connection (4) between the cover (3) and the base (2) with the possibility of moving the cover (3) relative the base (2) to close and open access to that area (7) of the lock of the protected object, which is necessary to open this lock, and elements for detecting the change in the position of the cover (3) are made with the possibility of interaction with the alarm system when the cover (3) moves relative to the base (2), characterized in that it contains a system for detecting the change in the state of the cover (5), which is formed at least from the cover (3), from the movable connection (4) between the cover (3) and the base (2) and at least from one electronic component (6), which, when the state of the cover (3) changes, interacts with the alarm system, while part of at least one of the elements of the system for detecting the change in the state of the cover (5) in the position of the alarm device (1), when the cover (3) closes area (7) of the lock of the protected object, access to which is necessary to open this lock, is located in front of this area (7) of the lock of protected object, access to which is necessary to open this lock.

2. The alarm device according to claim 1, characterized in that the base (2) contains an hole (8) for access to the lock of the protected object, which is made in that part of the base (2), which, when installing the alarm device (1) to the protected object, is located in the area (7) of the lock of the protected object, access to which is necessary to open this lock, while part of at least one of the elements of the system for detecting the change in the state of the cover (5) in the position of the alarm device (1) when the cover (3) covers the hole (8) of the base (2), located in front of this hole (8) to access the lock of protected object.

3. The alarm device according to claim 1 or claim 2, characterized in that the system for detecting changes in the state of the cover (5) is formed at least from the cover (3), from the movable connection (4) between the cover (3) and the base (2), and from at least one electronic component (6) such as a tilt sensor (12) or a mechanical tilt sensor that is made with ability to connect to the alarm system of the protected object and is located inside the cover (3), and which, when the cover (3) is moved relative to the base (2), interacts with the alarm system.

4. The alarm device according to claim 1 or claim 2, characterized in that the system for detecting the change in the state of the cover (5) is formed at least from the cover (3), a movable connection (4) between the cover (3) and the base (2), and at least one electronic component (6) such as a gyroscope (13), or an accelerometer (14), or a gyroscope-accelerometer (15), which is made with ability to be connected to the alarm system of the protected object and is located inside the cover (3) or in a movable connection (4) between the cover (3) and the base (2), and which, when the cover (3) moves relative to the base (2), interacts with the alarm system.

5. The alarm device according to claim 1 or claim 2, characterized in that the system for detecting changes in the state of the cover (5) is formed at least from cover (3) inside which there is at least one permanent magnet (17), the movable connection (4) between the cover (3) and the base (2), and at least one electronic component (6) such as a magnetically sensitive sensor (16), which is made with ability to be connected to the alarm system of the protected object, and which is located in the base (2), while magnetically sensitive the sensor (16), when the cover (3) moves relative to the base (2) or when the state of the cover (3) changes, interacts with the alarm system.

6. The alarm device according to claim 1 or claim 2, characterized in that the system for detecting changes in the state of the cover (5) is formed at least from the cover (3), which contains the inner plane (28), from a movable connection (4) between the cover (3) and the base (2) and at least of one electronic component (6) such as an electronic photosensitive member (18) which is made with ability to connect to the alarm system of the protected object, and which is located in the base (2) in such a way that its light-sensitive surface (29) is located to the inner plane (28) of cover (3), while the cover (3) has such an internal plane (28) that is covered with a material or contains material or is made of a material in which cracks or irregularities or a change in the surface pattern are formed as a result of mechanical or thermal effects, or it loses its light conductivity, and such an inner plane (28) of the cover (3) is located on the inner surface of the cover (3), which covers the outer side base (2), electronic photosensitive element (18), area (7) or hole (8) for access to the lock of the protected object in the position of the alarm device (1) with the closed cover (3), while the electronic photosensitive element (18) with changing the state of the cover (3) interacts with the alarm system.

7. The alarm device according to claim 1 or claim 2, characterized in that the system for detecting changes in the state of the cover (5) is formed at least from the cover (3), a movable connection (4) between the cover (3) and the base (2), and at least one electronic component (6) such as a flex sensor (19), which is fully or partially located in the movable connection (4), and is made with ability to connect to the alarm system of the protected object, and when the cover (3) moves relative to the base (2) interacts with the alarm system.

8. The alarm device according to any of claims 1-7, characterized in that additionally contains at least one radio module (20) or radio module (20) with cryptographic protection of the radio channel, which is installed inside the cover (3) or inside the base (2), and the radio module (20) is connected to at least one electronic component (6) of the system for detecting the change in the state of the cover (5), which, when the cover (3) is moved relative to the base (2) interacts with the alarm system, while the radio module (20) is configured to transmit a radio signal about a change in the state of the cover (3) to the alarm system or electronic-digital devices of persons observing the protected object.

9. The alarm device according to any of claims 1-8, characterized in that at least one electronic component (6) of the system for detecting a change in the state of the cover (5), which, when the state of the cover (3) changes, interacts with the alarm system, is connected to at least one resistor (21) or a variable resistor that is located inside the cover (3) either inside the base (2) or in the movable connection (4) between the cover (3) and base (2).

10. An alarm device according to any of claims 1-9, characterized in that at least one electronic component (6), which, when the state of the cover (3) changes, interacts with the alarm system, is connected to conductive wires (22) or installed on circuit board (23), in this case, part of these electrically conductive wires (22) or part of the electrical boards (23) in the position where the cover (3) covers the base (2) are located inside the cover (3) and/or in the movable connection (4) in front of the area (7) or in front of the hole (8) of the base (2) for access to the lock of the protected object, in addition, the electrically conductive wires (22) or the terminals of the circuit board (23) are connected to alarm system directly or using a radio signal.

11. The alarm device according to any of claims 1-10, characterized in that to at least one electronic component (6) of the system for detecting changes in the state of the cover (5), which, when the state of the cover (3) changes, interacts with the alarm system, is connected at least one magnetically sensitive sensor of type “Reed switch” (30), which is located inside the cover (3) or inside the base (2), or in a movable connection (4) between the cover (3) and the base (2).

12. The alarm device according to any of claims 1-11, characterized in that at least one of the two parts of the alarm device (1)—the cover (3) and/or the base (2) contains at least one (first) permanent magnet (31), while the other part of the alarm device (1) also contains at least one corresponding (second) permanent magnet (32) or contains a magnetic material (33), or is partially made of a magnetic material (33) that interacts with the first permanent magnet (31) or a corresponding second permanent magnet (32) of one of the two parts of the alarm device (1).

13. Alarm device according to any of the claims 1-12, characterized in that the movable connection (4) between the cover (3) and the base (2) is constructed and arranged at the bottom of alarm devices (1).

14. The alarm device according to any of claims 1-13, characterized in that the cover (3) and/or the base (2) contains a limiting element (11) for changing the position of the cover (3).

15. The alarm device according to any of claims 1-14, characterized in that it additionally contains an electric sound siren (34) installed inside the base (2) or inside the cover (3), and which is connected to a system for detecting changes in the state of the cover (5) and/or to an alarm system.

16. An alarm device according to any of claims 1-15, characterized in that it contains a radio frequency identification or near field communication module (35), which is installed inside the base (2) or inside the cover (3).

17. The alarm device according to any of claims 1-16, characterized in that it additionally contains a coded or mechanical, or electromagnetic, or electromechanical lock (36), which is configured to block the opening of the cover (3) when it is closed position.

18. The alarm device according to one of paragraphs 1-17, characterized in that the base (2) contains holes (9) for attaching the alarm device (1) to the protected object.

19. The alarm device according to any of claims 1-18, characterized in that it additionally contains an electrical switch (37) installed in the base (2) in such a way that when dismount/removing the alarm device (1) from the surface of the protected object, the electrical switch (37) interacts with the alarm system.

20. The alarm device according to any of claims 1-19, characterized in that contains a biometric scanner (38), which is located in the cover (3) or in the base (2).

21. The alarm device according to any of claims 1-20, characterized in the cover (3) contains a hole (10) for access to the lock of the protected object.

22. The alarm device according to any of claims 1-21, characterized in that it additionally contains at least one shock and/or vibration sensor (39), which is made with ability to be connected to the alarm system of the protected object and is located inside the cover (3) or inside the base (2), or in a movable connection (4) between the cover (3) and the base (2).

23. The alarm device according to any of claims 1-22, characterized in that it additionally contains at least one data input/output port (40), which is located inside the cover (3) or inside the base (2).

24. The alarm device according to any of claims 1-23, characterized in that it additionally contains at least one microcontroller (41), which is located inside the cover (3) or inside the base (2).

25. The alarm device according to any of claims 1-24, characterized in that it additionally contains at least one photo/video camera (42), which is located inside the cover (3) or inside the base (2).
